(19) United States
(12) Patent Application Publication
(10) Pub. No.: US 2013/0201161 A1
(43) Pub. Date: Aug. 8, 2013

(54) Methods, Systems and Apparatus for Digital-Marking-Surface Content-Unit Manipulation

(71) Applicants: John E. Dolan, Vancouver, WA (US); Basil Isaiah Jesudason, Portland, OR (US)

(72) Inventors: John E. Dolan, Vancouver, WA (US); Basil Isaiah Jesudason, Portland, OR (US)

(21) Appl. No.: 13/366,186

(22) Filed: Feb. 3, 2012

(51) Int. Cl. G06F 3/033

(52) U.S. Cl. 345/179

(57) ABSTRACT

Aspects of the present invention are related to systems, methods and apparatus for collecting and displaying digital-marking-surface content based on semantic tags. Some aspects of the present invention relate to ink gestures that invoke content-unit tagging. Some aspects of the present invention relate to ink gestures that invoke the collection and display of like-tagged content units. Some aspects of the present invention relate to ink gestures that invoke the restoration of a viewport or digital sheet to a pre-collection state. Some aspects of the present invention relate to manipulation of content units in a collection view and the persistence of the content-unit manipulations upon restoration of a pre-collect state. Some aspects of the present invention relate to action invocation from a collection view.

### FIELD OF THE INVENTION

Aspects of the present invention relate generally to a digital marking surface, and more particularly, to the collection and display of digital-marking-surface content based on semantic tags.

### BACKGROUND

A digital-marking-surface apparatus typically comprises a marking surface on which a user may place digital marks and on which other digital content may be displayed.

Digital marks may be placed by a user using a pen device, stylus, finger or other marking device or object. Additionally, other digital content, for example, an image, a video window, an application window, content associated with a remote desktop, web content, multimedia content or other digital content, may be displayed on a digital marking surface.

One example of a digital marking surface apparatus is an electronic whiteboard on which diagrams and text may be drawn and on which other digital content may be displayed. In this type of apparatus, a digital sheet corresponding to a spatial extent associated with the digital-marking-surface may be larger than the digital marking surface of the actual physical apparatus, and the physical, digital marking surface of the apparatus may be envisioned as a viewport onto the digital sheet.

In some digital-marking-surface interactions, digital marks and other digital content that are semantically related may be written onto or displayed on the digital marking surface in disparate spatial locations or may migrate to disparate spatial locations, even outside the viewport, through user interaction. A presenter may want to regroup semantically related content into a single region. For example, task items written onto the digital marking surface at various locations may be assigned to specific personnel, and the presenter may want to see a view in which all assigned items are grouped by assignee. However, with current apparatus, manual collection of digital-display-surface content is required. Therefore, a digital-marking-surface apparatus allowing digital rearrangement of classified content may be desirable.

### SUMMARY

Some embodiments of the present invention comprise methods, systems and apparatus for the collection and display of digital-marking-surface content based on semantic tags.

According to a first aspect of the present invention, a “tag” ink gesture may effectuate the tagging of a content unit spatially proximate to the “tag” ink gesture with a semantic or other tag value.

According to a second aspect of the present invention, a “collect” ink gesture may effectuate the collection and display of like-tagged content units.

According to a third aspect of the present invention, a “restore” ink gesture may effectuate the restoration of a viewport associated with a digital marking surface to a state immediately prior to receiving a “collect” ink gesture.

According to a fourth aspect of the present invention, a “restore” ink gesture may effectuate the restoration of a digital sheet associated with a digital marking surface to a state immediately prior to receiving a “collect” ink gesture.

According to a fifth aspect of the present invention, a content unit modification made in a collection view, wherein like-tagged content items may be displayed, may be persistent upon restoration of a viewport or digital sheet.

According to a sixth aspect of the present invention, a content unit addition to a collection view may be persistent upon restoration of a viewport or digital sheet.

According to a seventh aspect of the present invention, an action associated with a tag value may be invoked in a collection view.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating an exemplary digital-marking-surface system according to some embodiments of the present invention;

FIG. 2 is a picture illustrating the relationship of a physical, digital marking surface to a viewport and a digital sheet according to some embodiments of the present invention;

FIG. 3 is a picture illustrating the relationship between digital marks and ink units according to some embodiments of the present invention;

FIG. 4 is a picture illustrating an exemplary “tag” ink gesture and tagging action according to some embodiments of the present invention;

FIG. 5 is a picture illustrating an exemplary digital marking surface after a tagging action according to some embodiments of the present invention;

FIG. 6 is a picture illustrating conversion of a “tag” ink gesture to a persistent ink unit according to some embodiments of the present invention;

FIG. 7 is a picture illustrating a tag-values menu in response to detection of a “tag” ink gesture according to some embodiments of the present invention;

FIG. 8 is a picture illustrating a tag-types menu and a tag-values menu in response to detection of a “tag” ink gesture according to some embodiments of the present invention;

FIG. 9 is a picture illustrating the migration of content units from the viewport of a digital sheet to regions of the digital sheet that are not visible on the physical device;

FIG. 10 is a picture illustrating an exemplary “collect” ink gesture according to some embodiments of the present invention;

FIG. 11 is a picture illustrating the effect of a “collect” ink gesture according to some embodiments of the present invention;

FIG. 12 is a picture illustrating exemplary regions associated with collected content units in conjunction with associated tag values according to embodiments of the present invention;

FIG. 13 is a picture illustrating an exemplary re-association of a content unit in a collection view according to some embodiments of the present invention;

FIG. 14 is a picture illustrating an exemplary “restore” ink gesture according to some embodiments of the present invention;

FIG. 15 is a picture illustrating selection of tag values in conjunction with a “collect” ink gesture according to some embodiments of the present invention;

FIG. 16 is a picture illustrating selection of tag values in conjunction with a “collect” ink gesture according to some embodiments of the present invention;

FIG. 17 is a picture illustrating selection of tag values in conjunction with a “collect” ink gesture according to embodiments of the present invention;

FIG. 18 is a picture illustrating selection of a tag value in conjunction with a “collect” ink gesture according to some embodiments of the present invention;

FIG. 19 is a picture illustrating an action menu associated with a collected plurality of content units associated with a tag value according to some embodiments of the present invention;

FIG. 20A and FIG. 20B are a chart showing exemplary embodiments of the present invention comprising associating a tag value with a content unit in response to a “tag” ink gesture;

FIG. 21A, FIG. 21B and FIG. 21C are a chart showing exemplary embodiments of the present invention comprising associating a tag value with a content unit in response to a “tag” ink gesture;

FIG. 22A and FIG. 22B are a chart showing exemplary embodiments of the present invention comprising associating a tag value with a content unit in response to a “tag” ink gesture;

FIG. 23A, FIG. 23B and FIG. 23C are a chart showing exemplary embodiments of the present invention comprising collecting and displaying like-tagged content units in response to a “collect” ink gesture;

FIG. 24A, FIG. 24B, FIG. 24C and FIG. 24D are a chart showing exemplary embodiments of the present invention comprising collecting and displaying like-tagged content units in response to a “collect” ink gesture;

FIG. 25 is a chart showing exemplary embodiments of the present invention comprising modifying, in a collection view, a tag associated with a content unit;

FIG. 26 is a chart showing exemplary embodiments of the present invention comprising invoking an action associated with a collection of like-tagged content units;

FIG. 27 is a picture illustrating, according to embodiments of the present invention, modification of a content unit in a view showing a collection of like-tagged content units;

FIG. 28 is a picture illustrating, according to embodiments of the present invention, a restored digital sheet reflecting a content-unit modification made in a collection view;

FIG. 29 is a picture illustrating, according to embodiments of the present invention, addition of a new content unit in a view showing a collection of like-tagged content units;

FIG. 30 is a picture illustrating, according to embodiments of the present invention, a restored digital sheet reflecting an addition of a content unit in a collection view; and

FIG. 31 is a chart showing exemplary embodiments of the present invention comprising adding a content unit to a restored digital sheet, wherein the added ink unit is received on a collection view.

### DETAILED DESCRIPTION OF EXEMPLARY EMBODIMENTS

Embodiments of the present invention will be best understood by reference to the drawings, wherein like parts may be designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods, systems and apparatus of the present invention is not intended to limit the scope of the invention, but it is merely representative of the presently preferred embodiments of the invention.

Elements of embodiments of the present invention may be embodied in hardware, firmware and/or a non-transitory computer program product comprising a computer-readable storage medium having instructions stored thereon/in which may be used to program a computing system. While exemplary embodiments revealed herein may only describe one of these forms, it is to be understood that one skilled in the art would be able to effectuate these elements in any of these forms while resting within the scope of the present invention.

Although the charts and diagrams in the figures may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence.

It is understood by those with ordinary skill in the art that a non-transitory computer program product comprising a computer-readable storage medium having instructions stored thereon/in which may be used to program a computing system, hardware and/or firmware may be created by one of ordinary skill in the art to carry out the various logical functions described herein.

A digital-marking-surface apparatus typically comprises a marking surface on which a user may place digital marks and on which other digital content may be displayed. Digital marks may be placed by a user using a pen device, stylus, finger or other marking device or object. Additionally, other digital content, for example, an image, a video window, an application window, content associated with a remote desktop, web content, multimedia content or other digital content, may be displayed on a digital marking surface.

One example of a digital marking surface apparatus is an electronic whiteboard on which diagrams and text may be drawn and on which other digital content may be displayed. In this type of apparatus, a digital sheet corresponding to a spatial extent associated with the digital-marking-surface may be larger than the digital marking surface of the actual physical apparatus, and the physical, digital marking surface of the apparatus may be envisioned as a viewport onto the digital sheet.

In some digital-marking-surface interactions, digital marks and other digital content that are semantically related may be written onto or displayed on the digital marking surface in disparate spatial locations or may migrate to disparate spatial locations, even outside the viewport, through user interaction. A presenter may want to regroup semantically related content into a single region. For example, task items written onto the digital marking surface at various locations may be assigned to specific personnel, and the presenter may want to see a view in which all assigned items are grouped by assignee. However, with current apparatus, manual collection of digital-display-surface content is required. Therefore, a digital-marking-surface apparatus allowing digital rearrangement of classified content may be desirable.

Basic digital marks may be referred to as basic ink units, and more complex marks, composed of one, or more, basic ink units, may be referred to as compound ink units. For example, a single stroke, a cursive letter or a cursive word may constitute a basic ink unit, while some combination of these ink units, for example, a word, sentence, paragraph or other combination may constitute a compound ink unit. An ink unit or an encapsulated object associated with other digital content may constitute a digital-marking-surface content unit, also referred to as a content unit. Metadata may be associated with a content unit. Exemplary content-unit metadata may include, for example, the type of content unit, a property of the content unit, the origin of the content unit and other content-unit data.

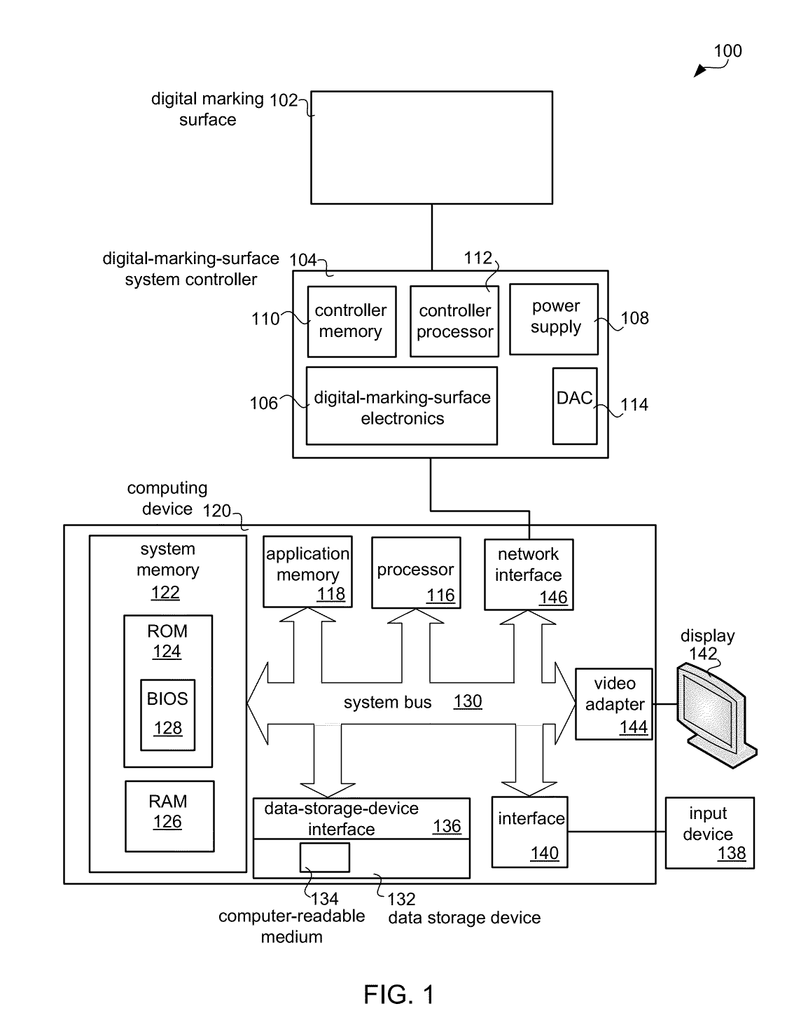

FIG. 1 illustrates an exemplary digital-marking-surface system 100 according to embodiments of the present invention. The digital-marking-surface system 100 may comprise a digital marking surface 102, for example, an interactive whiteboard, a touch-screen device or other digital marking surface. Some embodiments of the present invention may comprise an interactive whiteboard comprising a sensing technology for tracking an interaction on the digital marking surface 102. Exemplary sensing technologies include resistive sensing technologies, capacitive sensing technologies, active electromagnetic sensing technologies, passive electromagnetic sensing technologies, optical sensing technologies, for example, infrared based, laser based, camera based and other optical-based sensing technologies, ultrasonic sensing technologies, dispersive signal technologies and other sensing technologies.

A user may place a digital mark on the digital marking surface 102 using a marking device, for example, a mouse, a keyboard, a stylus, a specialized marking-device pen, a finger or other marking device capable of inputting a digital-ink mark on the digital marking surface 102. The digital marking surface 102 may also display digital images and other digital content.

The digital-marking-surface system 100 may comprise a digital-marking-surface system controller 104 for controlling the digital-marking-surface system 100. The digital-marking-surface system controller 104 may comprise digital-marking-surface electronics 106 for controlling the digital marking surface 102, for making measurements from the digital marking surface 102 and for other control functions associated with the digital-marking-surface system 100. The digital-marking-surface system controller 104 may comprise a power supply 108, a controller memory 110, a controller processor 112 and a digital-to-analog converter (DAC) 114. In some embodiments of the present invention (not shown), the digital-marking-surface system controller 104 may be physically integrated into a single apparatus with the digital marking surface 102. In alternative embodiments, the digital-marking-surface system controller 104 may be physically separate from, but electronically connected to, the digital marking surface 102.

The digital-marking-surface system 100 may comprise a processor 116 and an application memory 118. In some embodiments of the present invention (not shown), the processor 116 and the application memory 118 may be physically integrated into a single apparatus with the digital marking surface 102. In alternative embodiments of the present invention (not shown), the processor 116 and the application memory 118 may be physically integrated into a single apparatus with the digital-marking-surface system controller 104. In yet alternative embodiments of the present invention, the processor 116 and the application memory 118 may be separate from, but electronically connected to, one, or both, of the digital marking surface 102 and the digital-marking-surface system controller 104. In some embodiments of the present invention, the processor 116 and application memory 118 may reside in a computing device 120.

An exemplary computing device 120 may comprise system memory 122, which may comprise read-only memory (ROM) 124 and random-access memory (RAM) 126. The exemplary computing device 120 may comprise a basic input/output system (BIOS) 128, which may reside in ROM 124, for controlling the transfer of information between the components of the computing device 120 via a system bus 130. The exemplary computing device 120 may comprise one, or more, data storage devices (one shown) 132, for example, a hard disk drive, a magnetic disk drive, an optical disk drive or other data storage device, for reading from and writing to a computer-readable medium (one shown) 134, for example, a hard disk, an optical disk, a magnetic disk or other computer-readable medium. The exemplary computing device 120 may also comprise an associated data-storage-device interface 136 for connecting the data storage device 132 to the system bus 130.

A digital-marking-surface application program may be stored on the read-only memory 124, on the random-access memory 126 or on the one, or more, data storage devices 132. The digital-marking-surface application program may comprise instructions that, when executed, may control the digital-marking-surface system 100, may process input from the digital marking surface 102, may effectuate changes in the content displayed on the digital marking surface 102 and may otherwise implement a digital-marking-surface application program.

The exemplary computing device 120 may comprise an input device 138, for example, a mouse, a keyboard, a joystick or other input device, which may be connected, to the system bus 130, via an interface 140, for example, a parallel port, game port, universal serial bus or other interface.

The exemplary computing device 120 may comprise a display 142, which may be connected, via a video adapter 144, to the system bus 130.

The exemplary computing device 120 may be communicatively coupled with the digital-marking-surface system controller 104 via a network interface 146 or other communication connection.

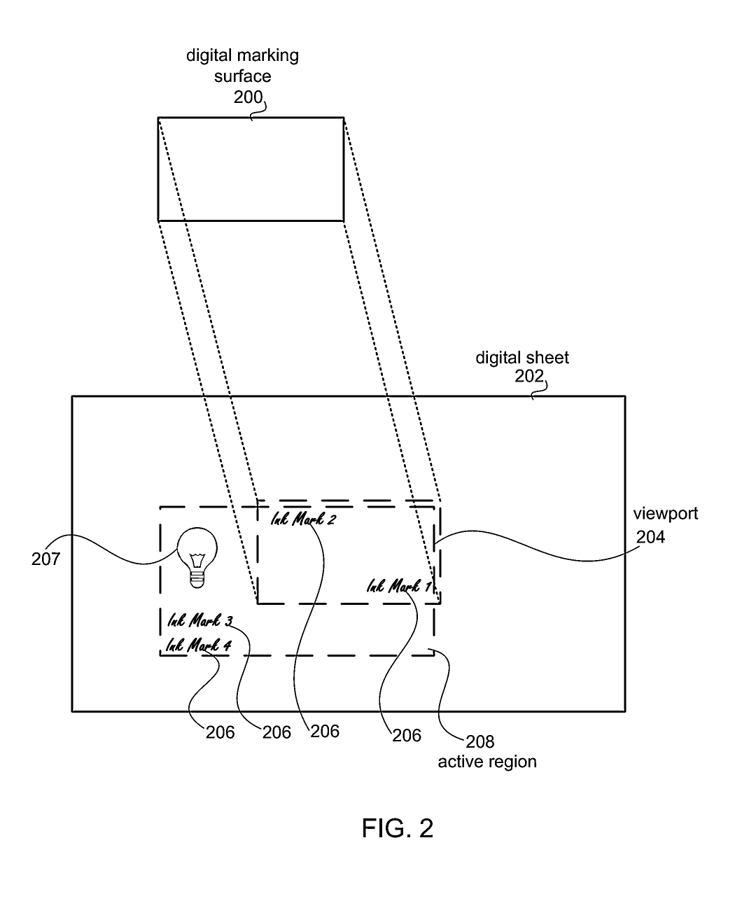

Some embodiments of the present invention may be understood in relation to FIG. 2. A digital marking surface 200, for example, an interactive whiteboard surface, touch-screen or other digital marking surface, may be associated with a digital sheet 202. The digital sheet 202 may correspond to a larger spatial region than the physical apparatus 200. The digital sheet 202 conceptually may be considered of infinite extent, but for implementation and practical purpose may be of finite extent, wherein the finite extent may be larger than the physical-apparatus extent in the horizontal and/or the vertical direction. In some embodiments of the present invention, the digital sheet 202 may be three times the dimension of the physical apparatus extent in both the horizontal direction and the vertical direction. The region of the digital sheet 202 that is currently viewable on the physical apparatus 200 may be referred to as the viewport 204. The region 208 of the digital sheet 202 that contains digital ink marks 206 and other digital content 207 may be referred to as the active region 208.

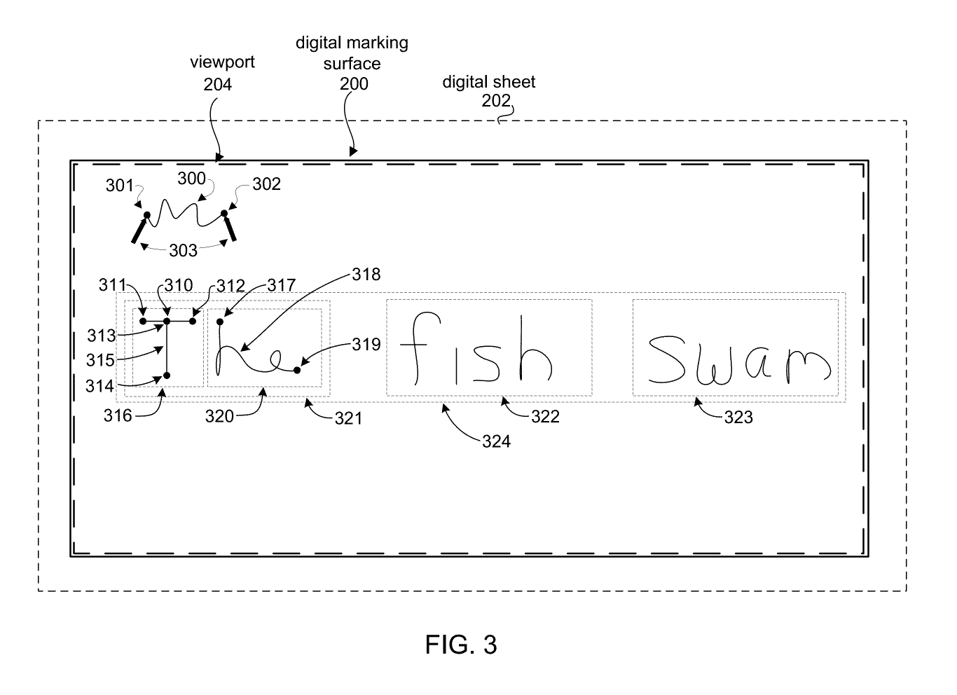

Some embodiments of the present invention may be understood in relation to FIG. 3. FIG. 3 depicts a digital marking surface 200. During use, a user may create a mark 300 with “digital ink” on the digital marking surface 200. Typically, a user will use a pen, stylus, finger or other digital marking device 303 to activate sensors that locate the digital marking device 303 relative to the digital marking surface 200 and place a mark 300 on the digital marking surface at the location of the digital marking device 303. A digital marking device 303 may comprise electronics or other components to enhance or enable detection, however, in some embodiments, a digital marking device 303 may simply be a user's finger or a dumb stylus. A digital marking device 303 may be anything used to make a digital mark on the digital marking surface 200.

Sensors of the digital-marking-surface system may detect the digital marking device 303 when the digital marking device 303 makes contact with the digital marking surface 200. This may be referred to as a “pen-down” action 301. Sensors of the digital-marking-surface system 100 may also detect a location at which the digital marking device 303 leaves contact with the digital marking surface 200. This may be referred to as a “pen-up” action 302.

The motion of the digital marking device 303 along the digital marking surface 200 between a pen-down action 301 and a pen-up action 302 may be used to define a digital mark 300. A digital mark 300 may take any shape and may relate to handwriting symbols, graphics or other marks. In typical use, digital marks will define alphanumeric characters and diagrammatical elements.

A digital-marking-surface system controller and/or a connected computing device may be used to identify digital marks through system sensors as the digital marks are input and to convert sensor input into an image of the digital mark displayed on the digital marking surface 200. Accordingly, as a user writes with a digital marking device 303 on the digital marking surface 200, a digital mark 300 appears on the digital marking surface 200 at the location of the digital marking device 303. When a digital mark is converted to an image displayed on the digital marking surface 200, that image of the mark may be referred to as a basic ink unit.

The digital-marking-surface system controller and/or a connected computing device may also function to aggregate basic ink units into compound ink units. A plurality of basic ink units may be aggregated into a single compound ink unit. For example, a series of handwritten characters may be aggregated into a word represented by a compound ink unit. As another example, a series of words represented by basic or compound ink units may be aggregated into another compound ink unit corresponding to a sentence or paragraph. Aggregation of ink units may be based on geometric relationships, semantic relationships and other relationships.

With further reference to FIG. 3, a user may place a mark by a pen-down action at a first location 311 followed by a horizontal stroke and pen-up action at a second location 312. In response, a digital-marking-surface system controller or a connected computing device draws a first basic ink unit 310 between the first location 311 and the second location 312. The system may then analyze first basic ink unit 310 to determine whether it conforms to any known character, symbol or predefined diagrammatic gesture description, also considered an ink gesture. If first basic ink unit 310 does not conform to any predefined diagrammatic gesture description, it may be left as a basic ink unit. The user may then place another mark on digital marking surface 200 with a pen-down action at a third location 313 followed by a stroke and a pen-up action at a fourth location 314. The system converts this mark into a second basic ink unit 315 displayed on the surface. The system then analyzes second basic ink unit and any other basic ink units proximate to second basic ink unit. In this example, first basic ink unit is proximate to second basic ink unit so first and second basic ink units are analyzed together to determine whether, together, they conform to a known description. In this case, the basic ink units are recognized as the letter “T” and are combined as a compound ink unit 316 comprising the alphanumeric character “T.” The user may then make another mark 318 with a pen-down action at a fifth location 317, a cursive stroke and a pen-up action at a sixth location 319. The digital-marking-surface system controller and/or a connected computing device may convert this action into a basic ink unit 320. This third basic ink unit may be analyzed and converted to a compound ink unit with the characters “h” and “e.” Because of the proximity and orientation of third basic ink unit 320 and compound ink unit 316, this combination of ink units may be analyzed and another compound ink unit 410 may be created to represent the word “The.” Similar processes may be used to create compound ink units 322, 323. Compound ink units may be further analyzed to determine further relationships. In this example, compound ink units 321-323 may be analyzed and found to constitute a sentence based on character recognition, grammatical rules and other relationships. Another compound ink unit 324 may be created to represent this sentence. Basic and compound ink units may be generated for strokes, characters, shapes, images and other diagrammatical objects and marks.

Some embodiments of the present invention may use Microsoft's Windows Presentation Foundation (WPF). WPF comprises a resolution-independent, vector-based rendering engine that works in conjunction with digital-marking-surface system controller and/or a connected computing device. Some embodiments may use Extensible Application Markup Language (XAML) markup along with managed programming language code stored on and implemented by digital-marking-surface system controller and/or a connected computing device.

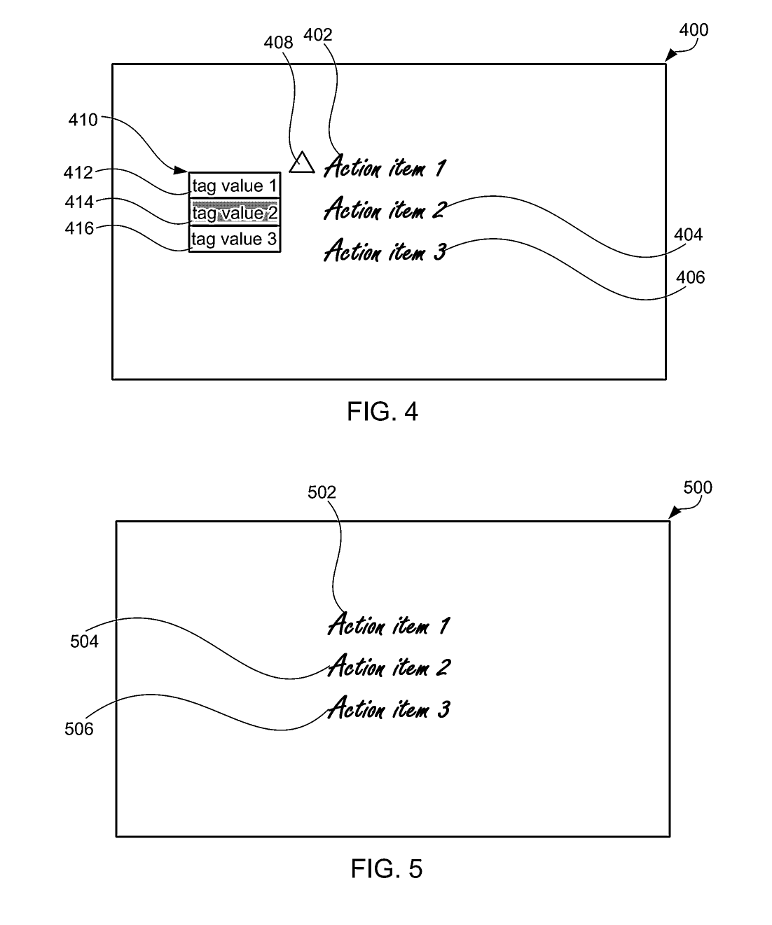

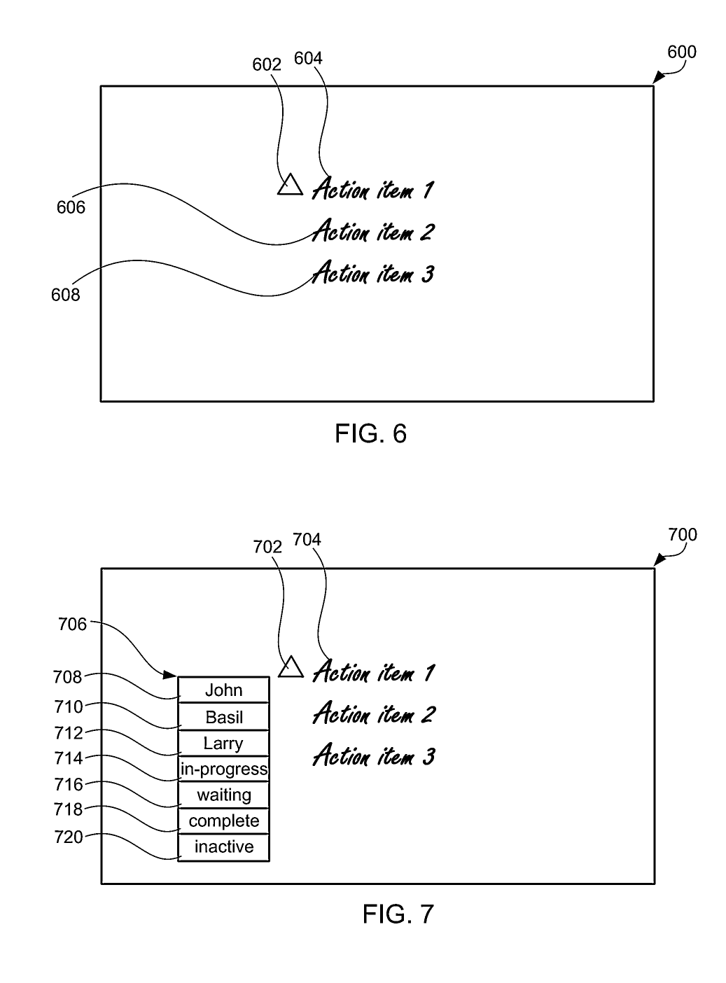

Some embodiments of the present invention may be described in relation to FIG. 4, FIG. 5 and FIG. 6. FIG. 4 depicts a digital marking surface 400 on which three content units 402, 404, 406, in this example, three ink units 402, 404, 406, have been placed. A user may place, on the digital marking surface 400, a previously defined digital ink mark 408, referred to as an ink gesture. The ink gesture 408 may be recognized as an ink gesture associated with a content-unit-tagging action, also referred to as a “tag” ink gesture, and a menu 410 of tag values (three shown) 412, 414, 416 may be displayed spatially proximate to the “tag” ink gesture 408. A user may select one of the tag values 412, 414, 416, for example, “tag value 2” 414. In some embodiments, the selected tag value menu item 414 may be indicated in the menu 410 by shading, by highlighting or by another method by which the selected tag value menu item 414 is displayed distinctly in comparison to the non-selected menu items 412, 416. A content unit, in this example, ink unit 402, located spatially proximate to the “tag” ink gesture 408 may be identified and the selected tag value may be associated with the identified content unit 402. The “tag” ink gesture 408 and the menu 410 of tag values may be removed from the digital marking surface 400.

FIG. 5 depicts the digital marking surface 500 after the tagging interaction. After the tagging interaction, the digital marking surface 500 may retain the content units (three shown) 502, 504, 506 displayed prior to the placement of the “tag” ink gesture. If a user fails to select a tag-value menu item within a timeout period, then the “tag” ink gesture 602 may be retained, along with the content units (three shown) 604, 606, 608 displayed prior to the placement of the ink gesture 602, on the digital marking surface 600 as an ink mark, and the menu of tag values may be removed, as illustrated in FIG. 6.

In some embodiments of the present invention, a first “tag” ink gesture, for example, an ink mark in the shape of a triangle, may be associated with a first plurality of tag values of a first tag class, also considered tag type, and a second “tag” ink gesture, for example, an ink mark in the shape of a star, may be associated with a second plurality of tag values of a second tag class. In these embodiments, a tag value menu displayed in response to the detection of “tag” ink gesture may contain the plurality of tag values associated with the detected “tag” ink gesture.

In some alternative embodiments, all tag values associated with a plurality of tag types may be associated with a “tag” ink gesture as illustrated in FIG. 7. FIG. 7 depicts a digital marking surface 700 on which a “tag” ink gesture 702 has been placed spatially proximate to a content unit 704, in this example, an ink unit 704. In response to detection of the “tag” ink gesture 702, a menu 706 of tag values (seven shown) 708, 710, 712, 714, 716, 718, 720 may be displayed, wherein the tag values 708, 710, 712, 714, 716, 718, 720 may be associated with two distinct tag types, for example, an ownership type and a status type.

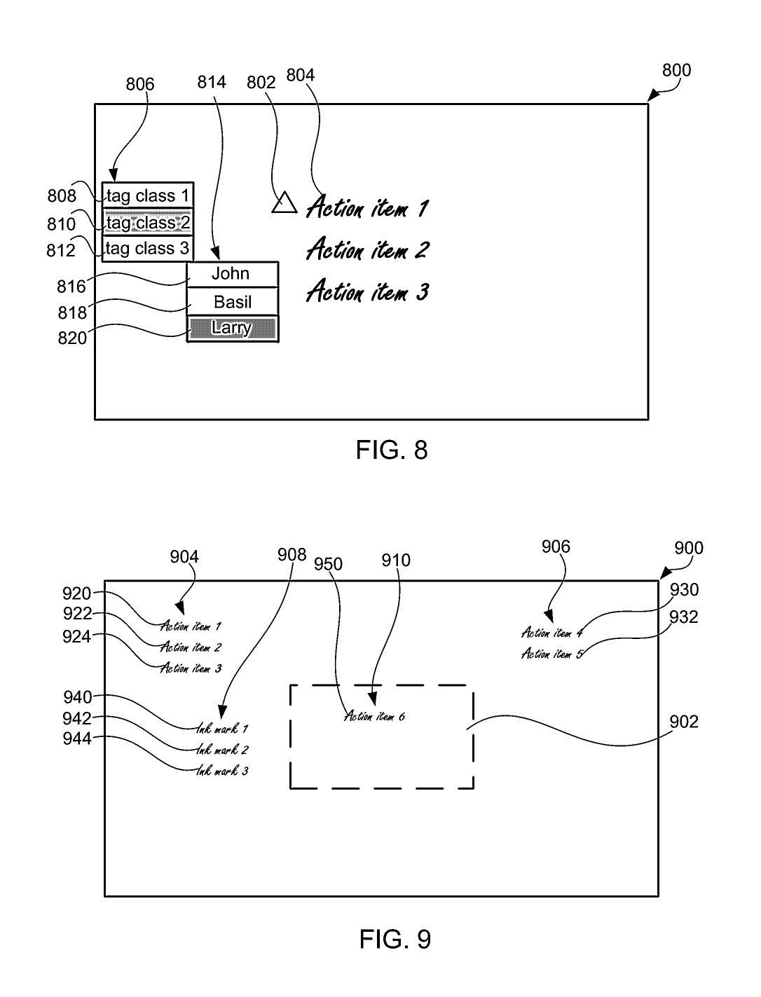

In some alternative embodiments of the present invention illustrated in FIG. 8, detection of a “tag” ink gesture 802 placed on a digital marking surface 800 may result in the display of a tag-type menu 806 of tag-type values (three shown) 808, 810, 812. Upon user selection of one of the tag-type menu 806 items, for example, “tag class 2” 810, a menu 814 of tag values (three shown) 816, 818, 820 associated with the selected tag type may be displayed. In some embodiments, the selected tag-type menu item 810 may be indicated in the menu 806 by shading, by highlighting or by another method by which the selected tag type menu item 810 is displayed distinctly in comparison to the non-selected menu items 808, 812. User selection of a tag value, for example, “Larry” 820, may effectuate the association of the selected tag value and corresponding tag type with a detected content unit 804, in this example, ink unit 804, located spatially proximate to the “tag” ink gesture 802.

In some embodiments of the present invention, tag values and/or tag types may be defined automatically at the initiation of a meeting session or other interactive session in a digital-marking-surface system. In an exemplary embodiment of the present invention, a “participant” tag type may defined automatically, wherein a plurality tag values associated with the “participant” tag type may correspond to the invitees to the interactive session, may correspond to the personnel in a default list of personnel associated with the session coordinator, may correspond to a default list of personnel associated with an interactive session topic, may correspond to another default list of personnel associated with the interactive session or may be inherited from a previous session in a series of related interactive session. In another exemplary embodiment of the present invention, a “status” tag type may be defined automatically, wherein a plurality of tag values associated with the “status” type may correspond to status levels, for example, “not yet started,” “in progress,” “waiting for input,” “inactive,” “complete” and other status levels. In another exemplary embodiment of the present invention, a “priority” tag type may be defined automatically, wherein a plurality of tags associated with the “priority” type may correspond to priority levels, for example, “low,” “medium,” “high,” “critical” and other priority levels. In another exemplary embodiment of the present invention, an “attribution” tag type may be defined, wherein a plurality of tag values may be defined associating attribution, or origination, of a content unit. In yet another exemplary embodiment of the present invention, a plurality of tag values, wherein the tag values are not associated with a tag type, may be defined. For example, the above examples may be defined without a corresponding tag type. A “tag” ink gesture may be associated with each tag type or plurality of tag values. A “tag” ink gesture may or may not be unique to a tag type or plurality of tag values.

In some embodiments of the present invention, a user may predefine a “tag” ink gesture and the associated tag type and/or tag values.

In some embodiments of the present invention, a menu-selection timeout period may be defined by a user, for example, a meeting coordinator or other user. If a user does not set a menu-selection timeout period value, the menu-selection timeout period may be set to a default value. In alternative embodiments of the present, the menu-selection timeout period may be a fixed, default value.

In some embodiments of the present invention, content units may be tagged semi-automatically. In these embodiments, manually tagged content units may be analyzed by a digital-marking-surface application to derive tagging patterns, for example, grammatical patterns, graphometric patterns and other tagging patterns. In some embodiments of the present invention, the analysis may comprise natural-language analysis. In alternative embodiments of the present invention, the analysis may comprise other learning methods known in the art, for example, supervised and unsupervised learning techniques. In some embodiments of the present invention, a pattern may be previously derived. The semi-automatic tagging system may update tagging patterns temporally and may monitor existing content units and newly added content units to determine if they satisfy a tagging pattern. When a content unit satisfies a tagging pattern, the content unit may be associated with a tag value corresponding to the tagging pattern. In some embodiments, a tag association may comprise a degree of association wherein the degree of association may be related to a measure of how strongly a tagging pattern may be matched. In some embodiments of the present invention, two degrees of association may be used: a hard association for manually tagged content units and a soft association for automatically tagged content units.

In some embodiments of the present invention, content units may be tagged automatically. In some embodiments, a content unit may be tagged, upon creation, based on a history of derived patterns and tags. In some embodiments of the present invention, patterns may be derived using contextual information, for example, session attendees, session tags, session agenda, a history associated with related sessions, session purpose and other contextual information. In some embodiments of the present invention, tagging patterns may evolve in a learning regime to improve the accuracy of the automated tagging over time. When a content unit satisfies a tagging pattern, the content unit may be associated with a tag value corresponding to the tagging pattern. In some embodiments, a tag association may comprise a degree of association wherein the degree of association may be related to a measure of how strongly a tagging pattern is matched. In some embodiments of the present invention, two degrees of association may be used: a hard association for manually tagged content units and a soft association for automatically tagged content units.

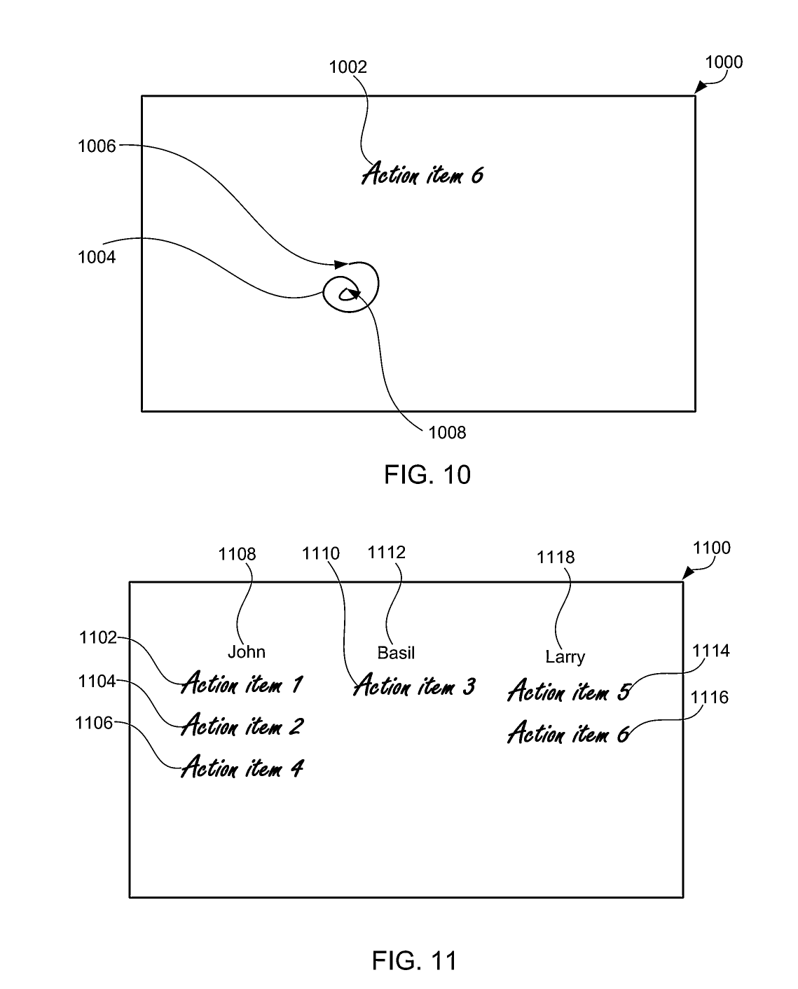

Some embodiments of the present invention may be understood in relation to an example illustrated by FIG. 9, FIG. 10 and FIG. 11. FIG. 9 depicts a digital sheet 900 associated with a digital-marking-surface. A viewport 902 may correspond to the portion of the digital sheet 900 that may be viewable on the physical digital marking surface. Several clusters (four shown) 904, 906, 908, 910 of content units are illustrated: a first cluster 904 containing three ink units 920, 922, 924, a second cluster 906 containing two ink units 930, 932, third cluster 908 containing three ink units 940, 942, 946, 948 and a fourth cluster 910 containing one ink unit 950. Only one ink unit 950 is visible in the viewport 902. For illustration purposes, let the following tagging associations exist: ink unit “Action item 1” 920 is tagged with tag value “John,” ink unit “Action item 2” 922 is tagged with tag value “John,” ink unit “Action item 3” is tagged with tag value “Basil,” ink unit “Action item 4” 930 is tagged with tag value “John,” ink unit “Action item 5” is tagged with tag value “Larry” and ink unit “Action item 6” is tagged with tag value “Larry.” The remaining ink units 940, 942, 944 are not tagged.

Referring to FIG. 10, which depicts the viewport 1000 and the content unit 1002, in this example, ink unit 1002, visible in the viewport 1000, a user may place an ink gesture 1004, on the digital marking surface. The ink gesture 1004 may be drawn starting at the outer-most point 1006 of the gesture and terminating at the inner-most point 1008. The starting point 1006 may be referred to as the pen-down point, and the termination point 1008 may be referred to as the pen-up point. The ink-gesture shape and the relative locations of the pen-down and pen-up points may indicate a “collect” ink gesture associated with a content-unit-collection action. Recognition of a “collect” ink gesture may effectuate the identification and display, in a collection view, of like-tagged content units. In this example, as illustrated in FIG. 11, ink units tagged “John” 1102, 1104, 1106 may be displayed spatially proximate to each other, and may be, in some embodiments, labeled “John” 1108, the associated tag value. Ink units tagged “Basil” 1110 may be displayed spatially proximate to each other, and may be, in some embodiments, labeled “Basil” 1112, the associated tag value. Ink units tagged “Larry” 1114, 1116 may be displayed spatially proximate to each other, and may be, in some embodiments, labeled “Larry” 1118. In some embodiments, the current digital sheet may be stored, and a new digital sheet may be created to facilitate the display of like-tagged content units. In alternative embodiments, digital content units displayed in the viewport of a current digital sheet may be temporarily removed and stored to facilitate the display of like-tagged content units.

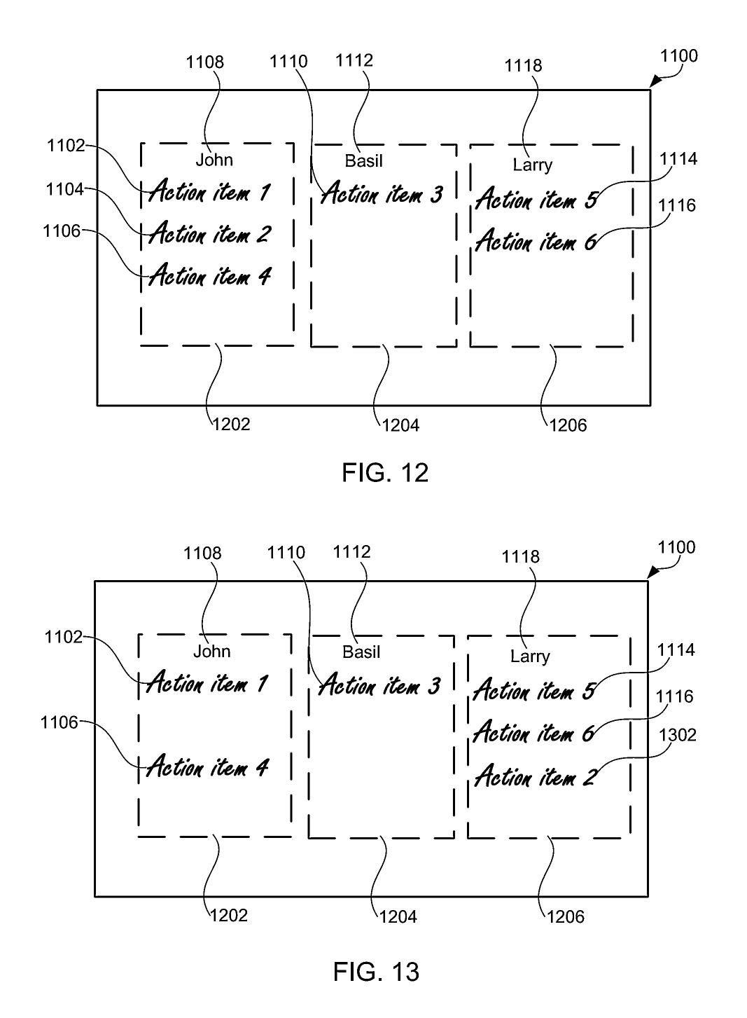

In some embodiments of the present invention described in relation to FIG. 12 and FIG. 13, a spatial region 1202, 1204, 1206 in the viewport 1100 may be associated with collected content units associated with each tag. A content unit may be drag-and-dropped from a first spatial region associated with a first tag value to another spatial region associated with a second tag value. The relocated content unit may be re-tagged to the second tag value. FIG. 13 illustrates the viewport 1100 after ink unit “Action item 2” 1302 has been dragged-and-dropped from the spatial region 1202 associated with the “John” tag to the spatial region 1206 associated with the “Larry” tag. The tag associated with the ink unit “Action item 2” 1302 may be changed from “John” to “Larry.”

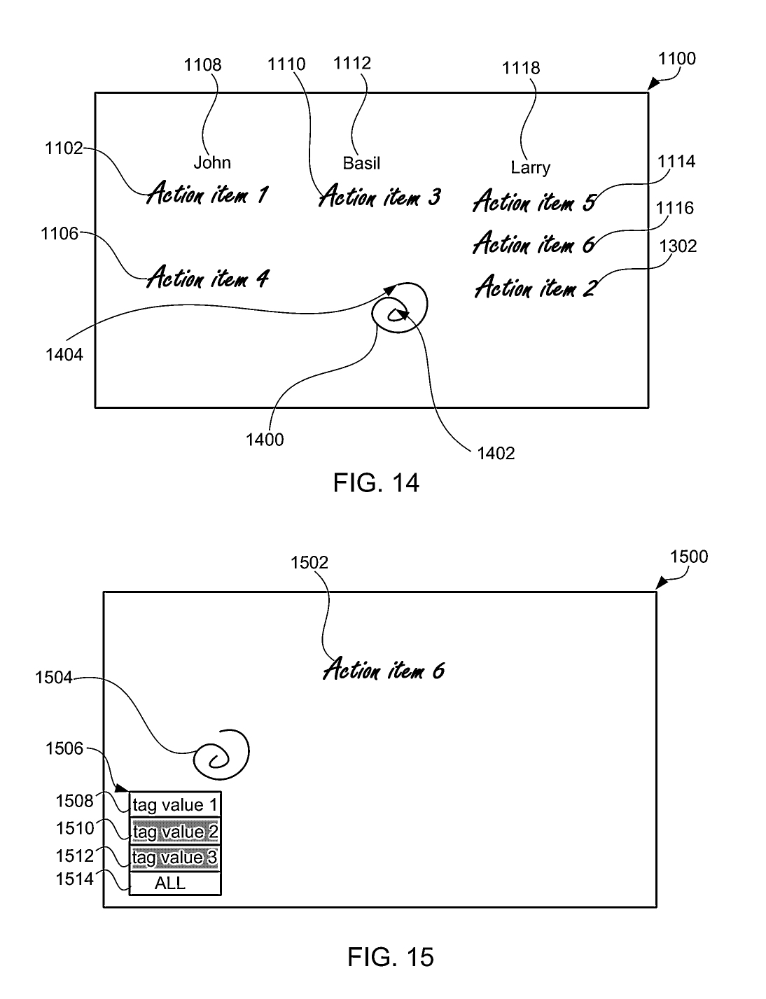

Referring to FIG. 14, which depicts the viewport 1100 of a collection view, a user may place an ink gesture 1400, on the digital marking surface. The ink gesture 1400 may be drawn starting at the inner-most point 1402 of the gesture and terminating at the outer-most point 1404. The starting point 1402 may be referred to as the pen-down point, and the termination point 1404 may be referred to as the pen-up point. The ink-gesture shape and the relative locations of the pen-down and pen-up points may indicate a “restore” ink gesture associated with a restore action. Recognition of a “restore” ink gesture may effectuate the restoration of digital marking surface to the state prior to receiving a “collect” ink gesture. In some embodiments of the present invention, the current digital sheet may be reset to the stored digital sheet. In alternative embodiments, the temporarily removed ink units may be restored to the viewport region of the current digital sheet.

In some embodiments of the present invention described in relation to FIG. 15 which depicts a viewport 1500 with an ink unit 1502 and an ink gesture 1504, upon recognition of the ink gesture 1504 as a “collect” ink gesture 1504, a menu 1506 of tag values 1508, 1510, 1512, 1514 may be displayed spatially proximate to the “collect” ink gesture 1504. A user may select one, or more, tag values 1508, 1510, 1512, 1514 for which the collect action may be performed. In some embodiments of the present invention, one of the menu items may be an item 1514 indicating that the collect action may be performed for all tag values. If a user fails to select a tag-value menu item within a timeout period, then the “collect” ink gesture 1504 may be retained, along with the content units (one shown) 1502 displayed prior to the placement of the “collect” ink gesture 1504, as an ink mark, and the menu 1506 of tag values may be removed. If a user selects one, or more, tag-value menu items before the timeout period elapses, then the collect action may be effectuated, and the tag-value menu 1506 may be removed from the viewport 1500. In some embodiments, the selected tag-value menu item(s) 1510, 1512 may be indicated in the menu 1506 by shading, by highlighting or by another method by which the selected tag value menu item(s) 1510, 1512 is/are displayed distinctly in comparison to the non-selected menu items 1508, 1514.

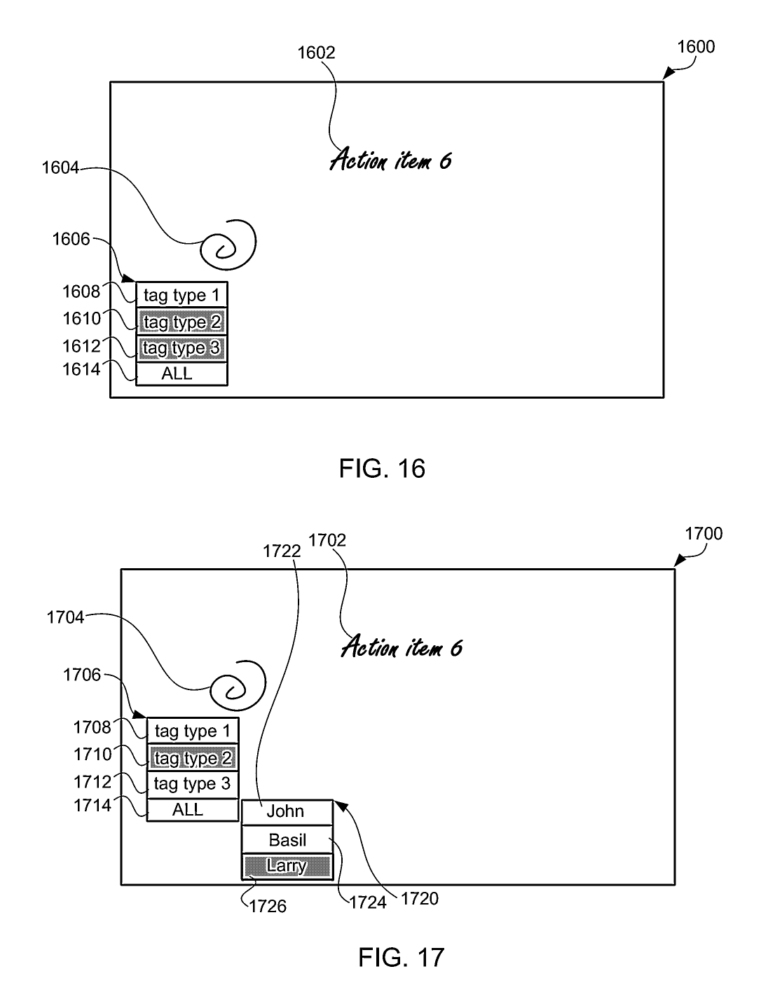

Alternative embodiments of the present invention may be described in relation to FIG. 16 which depicts a viewport 1600 with an ink unit 1602 and an ink gesture 1604, upon recognition of the ink gesture 1604 as a “collect” ink gesture 1604, a menu 1606 of tag types 1608, 1610, 1612, 1614 may be displayed. A user may select one, or more, tag types 1608, 1610, 1612, 1614 for which the collect action may be performed. In some embodiments of the present invention, one of the menu items may be an item 1614 indicating that the collect action may be performed for all tag types. Content units tagged with tag values associated with a selected tag type may be collected. If a user fails to select a tag-type menu item within a timeout period, then the “collect” ink gesture 1604 may be retained, along with the content units (one shown) 1602 displayed prior to the placement of the “collect” ink gesture 1604, as an ink mark, and the menu 1606 of tag types may be removed. If a user selects one, or more, tag-type menu items before the timeout period elapses, then the collect action may be effectuated, and the tag-type menu 1606 may be removed from the viewport 1600. In some embodiments, the selected tag-type menu item(s) 1610, 1612 may be indicated in the menu 1606 by shading, by highlighting or by another method by which the selected tag value menu item(s) 1610, 1612 is/are displayed distinctly in comparison to the non-selected menu items 1608, 1614.

Alternative embodiments of the present invention may be described in relation to FIG. 17 which depicts a viewport 1700 with an ink unit 1702 and an ink gesture 1704, upon recognition of the ink gesture 1704 as a “collect” ink gesture 1704, a menu 1706 of tag types 1708, 1710, 1712, 1714 may be displayed. A user may select one, or more, tag types 1708, 1710, 1712, 1714, and a menu 1720 of tag values 1722, 1724, 1726 associated with the selected tag type 1710 may be displayed. A user may select one, or more, tag values, associated with the selected tag type, for which the collect action may be performed. In some embodiments of the present invention, one of the menu items may be an item 1714 indicating that the collect action may be performed for all tag types. If a user fails to select a menu item within a timeout period, then the “collect” ink gesture 1704 may be retained, along with the content units (one shown) 1702 displayed prior to the placement of the ink gesture 1704, as an ink mark, and the tag-type menu 1706 and tag-value menu 1722 may be removed. If a user selects one, or more, tag-type menu items and one, or more, tag-value menu items before the timeout period elapses, then the collect action may be effectuated, and the menus 1706, 1720 may be removed from the viewport 1700. In some embodiments, the selected menu item(s) 1710, 1726 may be indicated in a menu 1706, 1720 by shading, by highlighting or by another method by which the selected tag value menu item(s) 1710, 1720 is/are displayed distinctly in comparison to the non-selected menu items 1708, 1712, 1714, 1722, 1724.

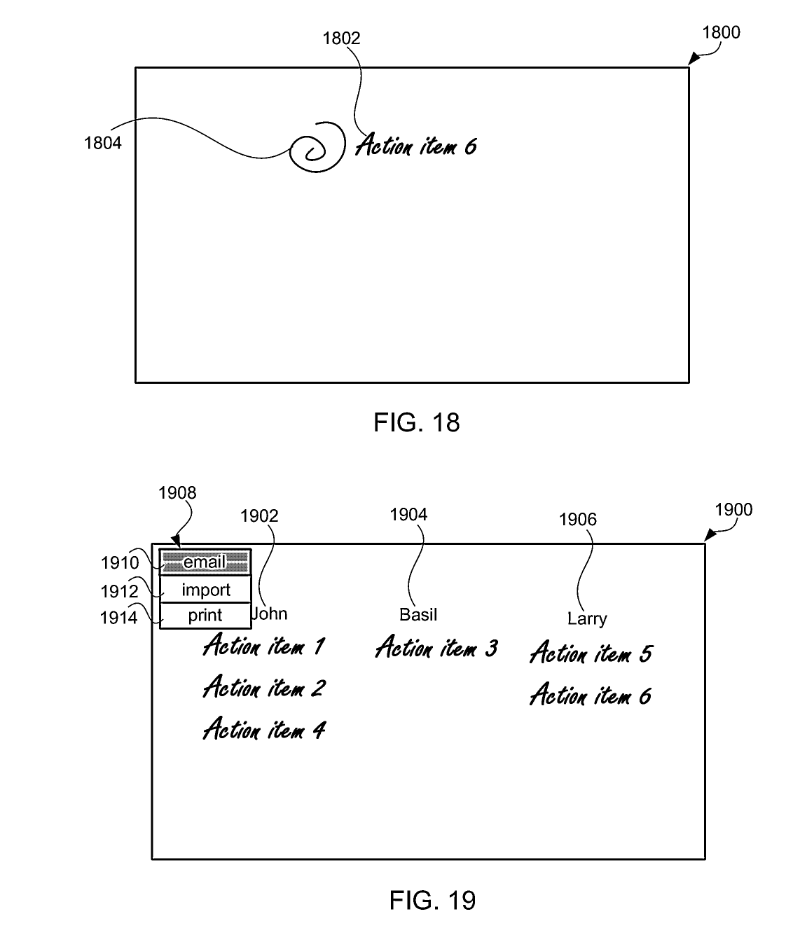

In alternative embodiments of the present invention described in relation to FIG. 18, which depicts a viewport 1800 with an ink unit 1802 and an ink gesture 1804, upon recognition of the ink gesture 1804 as a “collect” ink gesture 1804, a tag value for the collection action may be determined by identifying a tagged content unit, in this example, ink unit, within close proximity to the “collect” ink gesture 1804 and then performing the collect action using the tag value of the identified tagged content unit 1802.

Some embodiments of the present invention may be described in relation to FIG. 19. FIG. 19 illustrates a viewport 1900 on which is shown a collection view with three tag values 1902, 1904, 1906. In response to a user touch in a region proximate to a tag label, an action menu 1908 may be displayed. The action menu 1908 may comprise a plurality of actions 1910, 1912, 1914 associated with the tag value corresponding to the user-touched tag label 1902. Exemplary actions may include emailing an image of the collected content units associated with the tag to one, or more, email addresses associated with the tag value, importing the collected content units associated with the tag to a remote application associated with the tag value, for example, a calendar application, a task-list application, a document-processing application, an image-processing application or other application, printing the collected content units associated with the tag to a printer associated with the tag value and other actions. If a user fails to select an action-menu item within a timeout period, then the action-menu 1908 may be removed. If a user selects one, or more, action-menu items before the timeout period elapses, then the selected action(s) may be effectuated, and the action-menu 1908 may be removed from the viewport 1900. In some embodiments, the selected menu item(s) 1910 may be indicated in the action menu 1908 by shading, by highlighting or by another method by which the selected tag value menu item(s) 1910 is/are displayed distinctly in comparison to the non-selected menu items 1912, 1914.

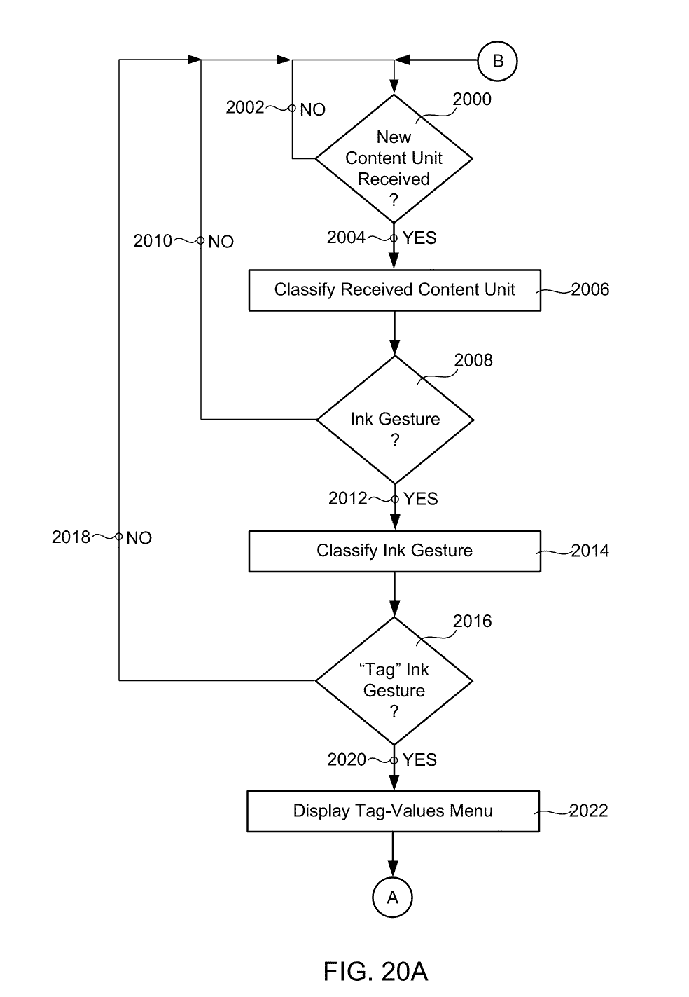

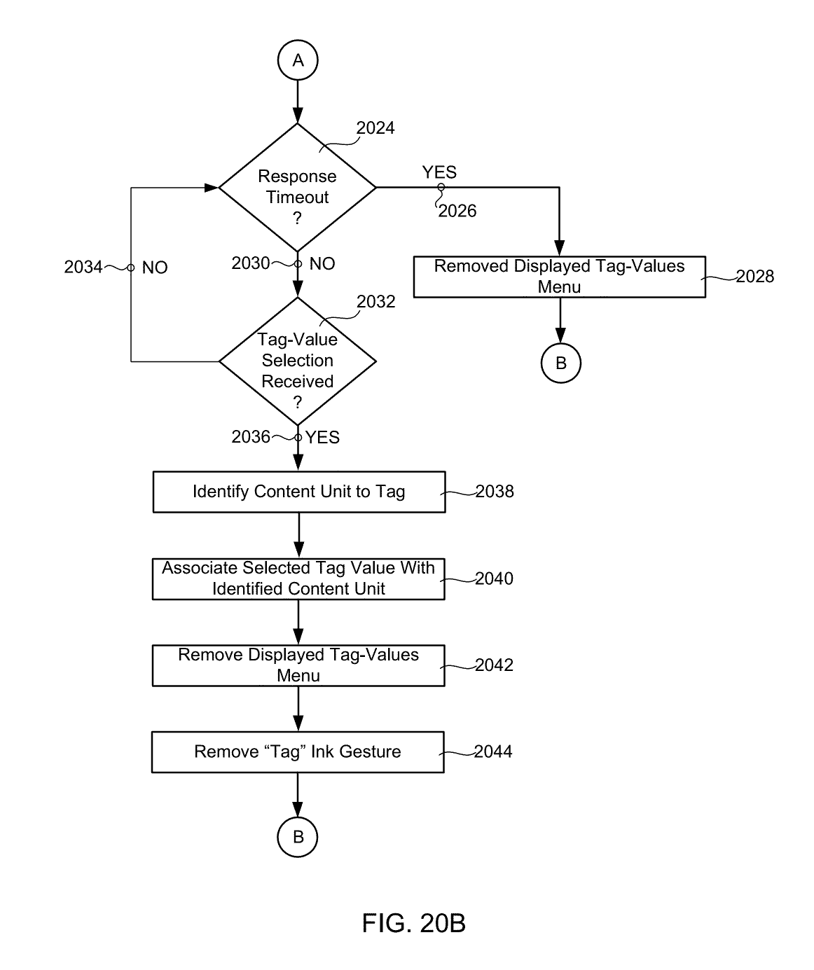

Some embodiments of the present invention may be described in relation to FIG. 20A and FIG. 20B. A determination may be made 2000 as to whether or not a new content unit has been received. If a new content unit has not been received 2002, then the content-unit monitoring 2000 may continue. If a new content unit has been received 2004, then the received content unit may be classified 2006. The content-unit classification results may be examined 2008 to determine if the received content unit may be classified as an ink gesture. If the received content unit may not be classified 2010 as an ink gesture, then the content-unit monitoring 2000 may continue. If the received content unit may be classified 2012 as an ink gesture, then the ink gesture may be classified 2014. The ink-gesture classification results may be examined 2016 to determine if the ink gesture may be classified as a “tag” ink gesture. If the ink gesture may not be classified 2018 as a “tag” ink gesture, then the content-unit monitoring 2000 may continue. If the ink gesture may be classified 2020 as a “tag” ink gesture, then a menu of tag values may be displayed 2022 in spatial proximity to the “tag” ink gesture. The time elapsed since the display of the tag-values menu may be examined 2024, and if the elapsed time is greater than a timeout value 2026, then the tag-values menu may be removed 2028 from the digital marking surface, and the content-unit monitoring 2000 may continue. If the elapsed time is not greater than the timeout value 2030, then a determination may be made 2032 as to whether or not a tag-value selection has been received. If a tag-value selection has not been received 2034, then the elapsed-time monitoring 2024 may continue. If a tag-value selection has been received 2036, then a content unit to tag may be identified 2038. In some embodiments of the present invention, the content unit spatially nearest to the “tag” ink gesture may be identified 2038 as the content unit to tag. The selected tag value may be associated 2040 with the identified content unit. In some embodiments of the present invention, the selected tag value may be associated 2040 with the identified content unit as metadata. The tag-values menu may be removed 2042 from the digital marking surface, and the “tag” ink gesture may be removed 2044 from the digital marking surface. The content-unit monitoring 2000 may continue.

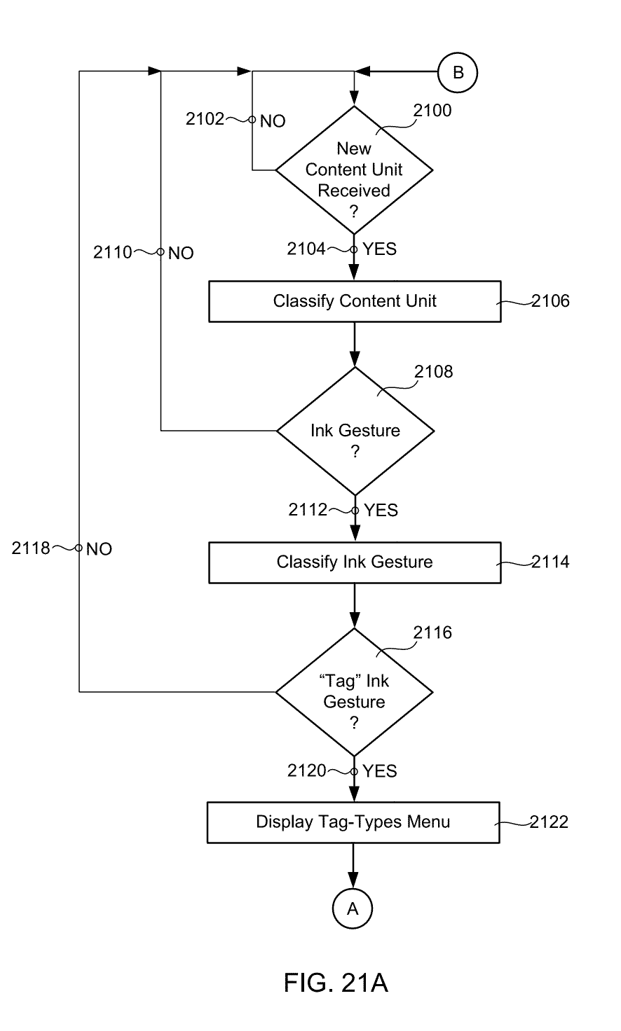

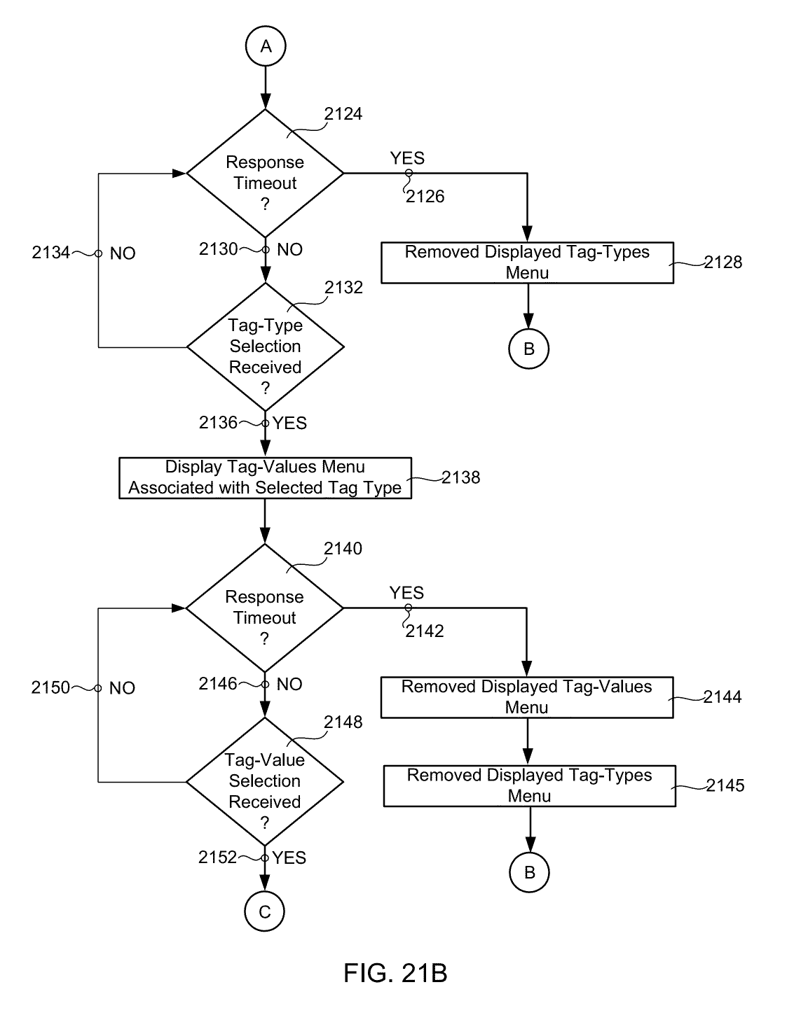

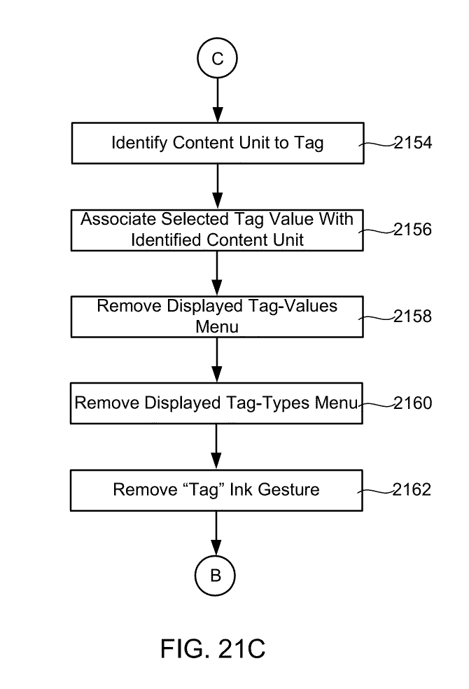

Some embodiments of the present invention may be described in relation to FIG. 21A, FIG. 21B and FIG. 21C. A determination may be made 2100 as to whether or not a new content unit has been received. If a new content unit has not been received 2102, then the content-unit monitoring 2100 may continue. If a new content unit has been received 2104, then the received content unit may be classified 2106. The content-unit classification results may be examined 2108 to determine if the received content unit may be classified as an ink gesture. If the received content unit may not be classified 2110 as an ink gesture, then the content-unit monitoring 2100 may continue. If the received content unit may be classified 2112 as an ink gesture, then the ink gesture may be classified 2114. The ink-gesture classification results may be examined 2116 to determine if the ink gesture may be classified as a “tag” ink gesture. If the ink gesture may not be classified 2118 as a “tag” ink gesture, then the content-unit monitoring 2100 may continue. If the ink gesture may be classified 2120 as a “tag” ink gesture, then a menu of tag types, also considered tag classes, may be displayed 2122 in spatial proximity to the ink gesture. The time elapsed since the display of the tag-types menu may be examined 2124, and if the elapsed time is greater than a timeout value 2126, then the tag-types menu may be removed 2128 from the digital marking surface, and the content-unit monitoring 2100 may continue. If the elapsed time is not greater than the timeout value 2130, then a determination may be made 2132 as to whether or not a tag-type selection has been received. If a tag-type selection has not been received 2134, then the elapsed-time monitoring 2124 may continue. If a tag-type selection has been received 2136, then a menu of tag values associated with the selected tag type may be displayed 2138. The time elapsed since the display of the tag-values menu may be examined 2140, and if the elapsed time is greater than a timeout value 2142, then the tag-values menu may be removed 2144 from the digital marking surface, and the tag-types menu may be removed 2145 from the digital marking surface. If the elapsed time is not greater than the timeout value 2146, then a determination may be made 2148 as to whether or not a tag-value selection has been received. If a tag-value selection has not been received 2150, then the elapsed-time monitoring 2140 may continue. If a tag-value selection has been received 2152, then a content unit to tag may be identified 2154. In some embodiments of the present invention, the content unit spatially nearest to the “tag” ink gesture may be identified 2154 as the content unit to tag. The selected tag value may be associated 2156 with the identified content unit. In some embodiments of the present invention, the selected tag value may be associated 2156 with the identified content unit as metadata. The tag-values menu may be removed 2158 from the digital marking surface, the tag-types menu may be removed 2160 from the digital marking surface, and the “tag” ink gesture may be removed 2162 from the digital marking surface. The content-unit monitoring 2100 may continue.

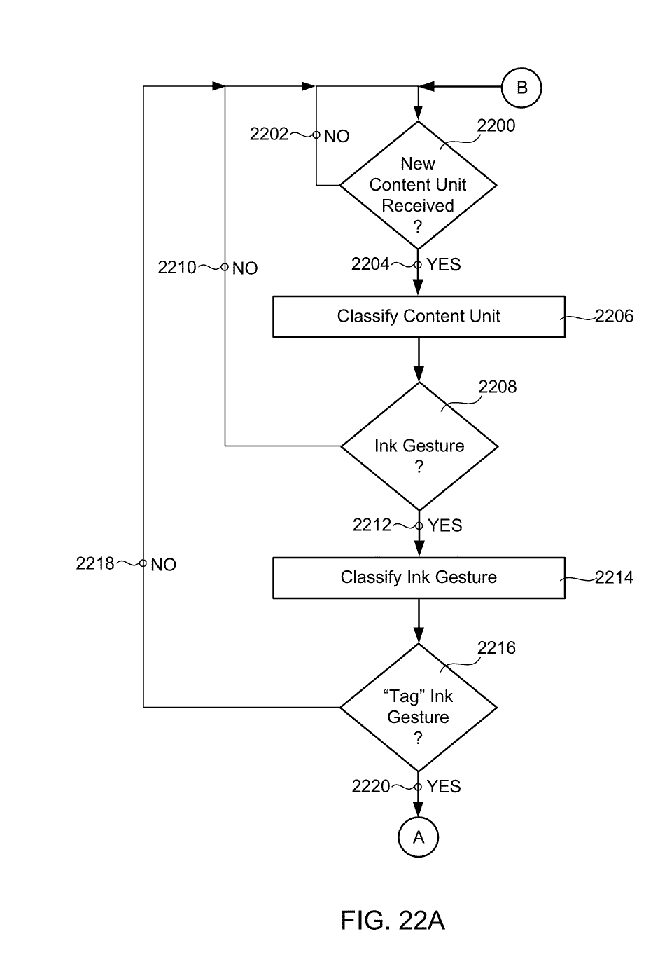

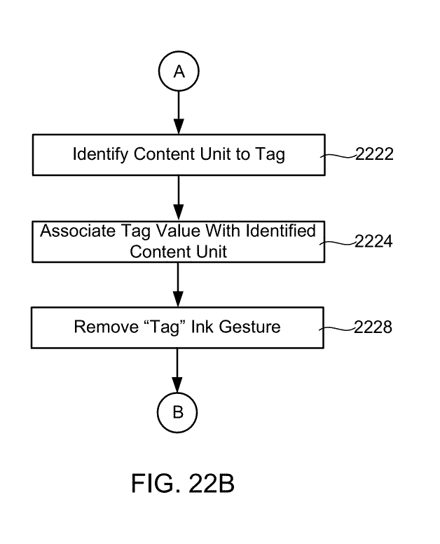

Some embodiments of the present invention may be described in relation to FIG. 22A and FIG. 22B. A determination may be made 2200 as to whether or not a new content unit has been received. If a new content unit has not been received 2202, then the content-unit monitoring 2200 may continue. If a new content unit has been received 2204, then the received content unit may be classified 2206. The content-unit classification results may be examined 2208 to determine if the received content unit may be classified as an ink gesture. If the received content unit may not be classified 2210 as an ink gesture, then the content-unit monitoring 2200 may continue. If the received content unit may be classified 2212 as an ink gesture, then the ink gesture may be classified 2214. The ink-gesture classification results may be examined 2216 to determine if the ink gesture may be classified as a “tag” ink gesture. If the ink gesture may not be classified 2218 as a “tag” ink gesture, then the content-unit monitoring 2200 may continue. If the ink gesture may be classified 2220 as a “tag” ink gesture, then a content unit to tag may be identified 2222. In some embodiments of the present invention, the content unit spatially nearest to the “tag” ink gesture may be identified 2222 as the content unit to tag. A tag value corresponding to the “tag” ink gesture may be associated 2224 with the identified content unit. In some embodiments of the present invention, the selected tag value may be associated 2224 with the identified content unit as metadata. The “tag” ink gesture may be removed 2228 from the digital marking surface. The content-unit monitoring 2200 may continue.

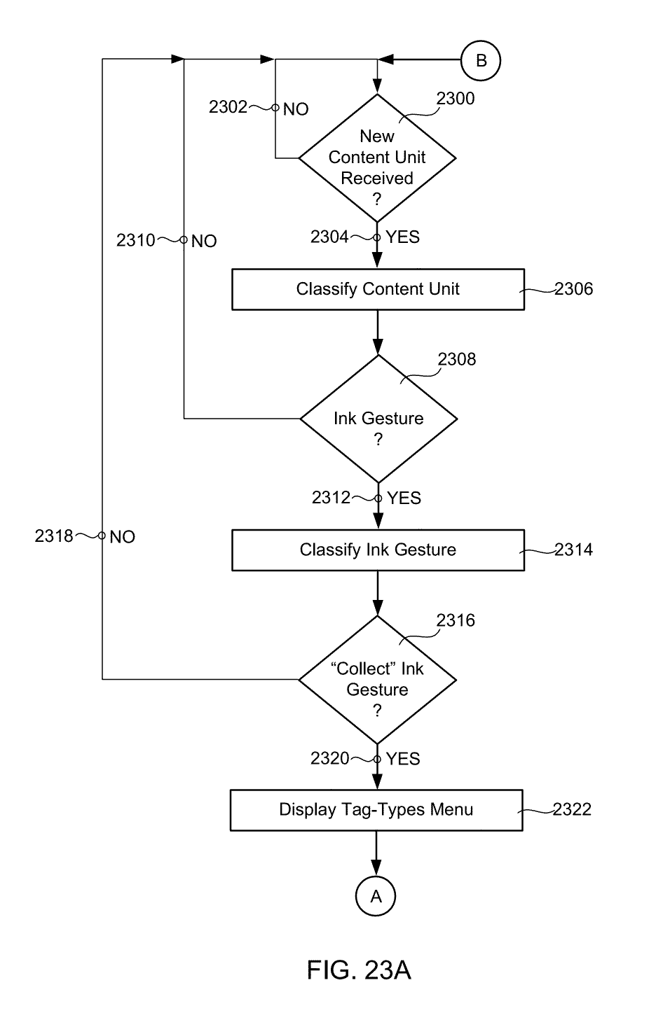

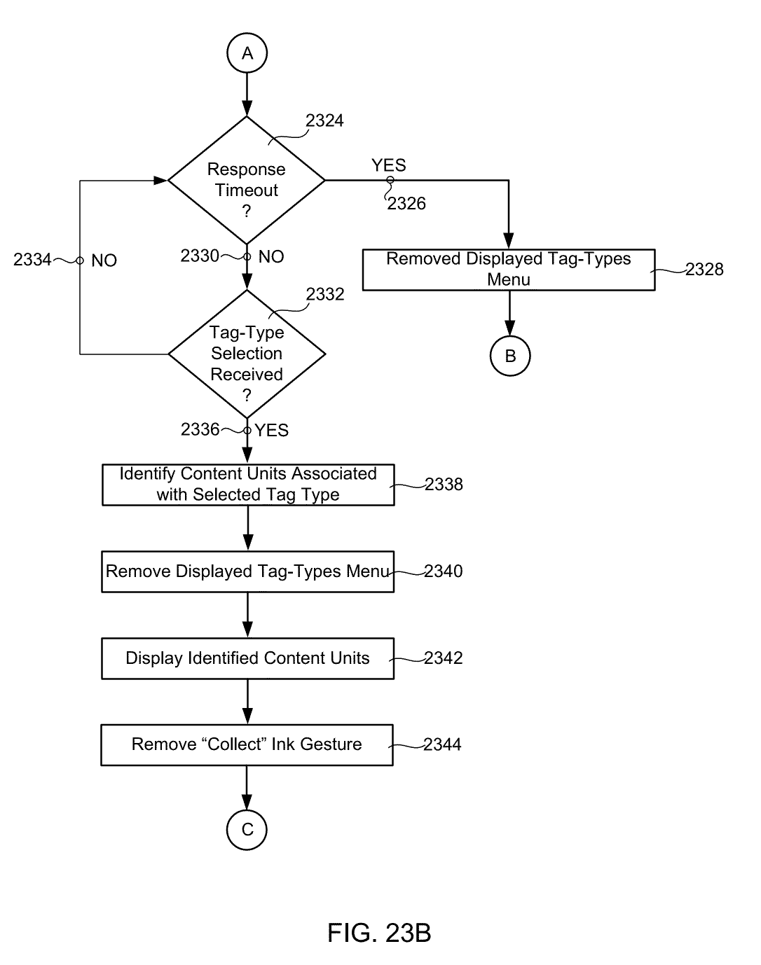

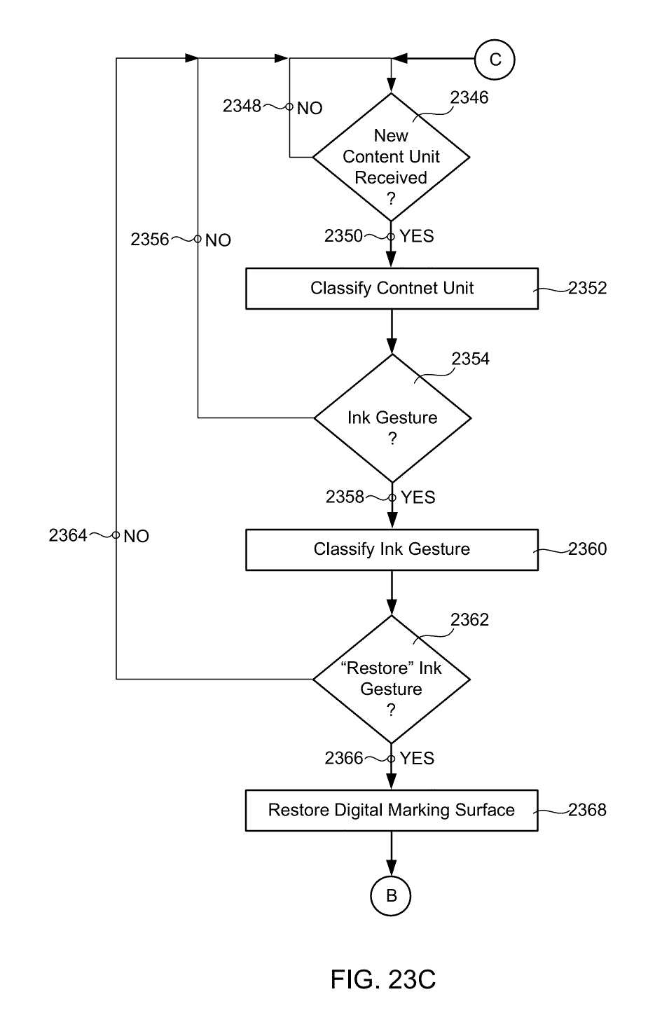

Some embodiments of the present invention may be described in relation to FIG. 23A, FIG. 23B and FIG. 23C. A determination may be made 2300 as to whether or not a new content unit has been received. If a new content unit has not been received 2302, then the content-unit monitoring 2300 may continue. If a new content unit has been received 2304, then the received content unit may be classified 2306. The content-unit classification results may be examined 2308 to determine if the received content unit may be classified as an ink gesture. If the received content unit may not be classified 2310 as an ink gesture, then the content-unit monitoring 2300 may continue. If the received content unit may be classified 2312 as an ink gesture, then the ink gesture may be classified 2314. The ink-gesture classification results may be examined 2316 to determine if the ink gesture may be classified as a “collect” ink gesture. If the ink gesture may not be classified 2318 as a “collect” ink gesture, then the content-unit monitoring 2300 may continue. If the ink gesture may be classified 2320 as a “collect” ink gesture, then a menu of tag types may be displayed 2322 in spatial proximity to the “collect” ink gesture. The time elapsed since the display of the tag-values menu may be examined 2324, and if the elapsed time is greater than a timeout value 2326, then the tag-types menu may be removed 2328 from the digital marking surface, and the content-unit monitoring 2300 may continue. If the elapsed time is not greater than the timeout value 2330, then a determination may be made 2332 as to whether or not a tag-type selection has been received. If a tag-type selection has not been received 2334, then the elapsed-time monitoring 2324 may continue. If a tag-type selection has been received 2336, then content units tagged with tags in the selected tag type may identified 2338. The tag-types menu may be removed 2340 from the digital marking surface, the identified content units may be displayed 2342 and the “collect” ink gesture may be removed 2344 from the digital marking surface. In some embodiments of the present invention, the removal 2344 of the “collect” ink gesture from the digital marking surface may be effectuated by clearing the viewport or initiating a new digital sheet prior to displaying 2342 the identified content units.

A determination may be made 2346 as to whether or not a new content unit has been received. If a new content unit has not been received 2348, then the content-unit monitoring 2346 may continue. If a new content unit has been received 2350, then the received content unit may be classified 2352. The content-unit classification results may be examined 2354 to determine if the received content unit may be classified as an ink gesture. If the received content unit may not be classified 2356 as an ink gesture, then the content-unit monitoring 2346 may continue. If the received content unit may be classified 2358 as an ink gesture, then the ink gesture may be classified 2360. The ink-gesture classification results may be examined 2362 to determine if the ink gesture may be classified as a “restore” ink gesture. If the ink gesture may not be classified 2364 as a “restore” ink gesture, then the content-unit monitoring 2346 may continue. If the ink gesture may be classified 2366 as a “restore” ink gesture, then the digital marking surface may be restored 2368 to the pre-collect action display. The content-unit monitoring 2300 may continue.

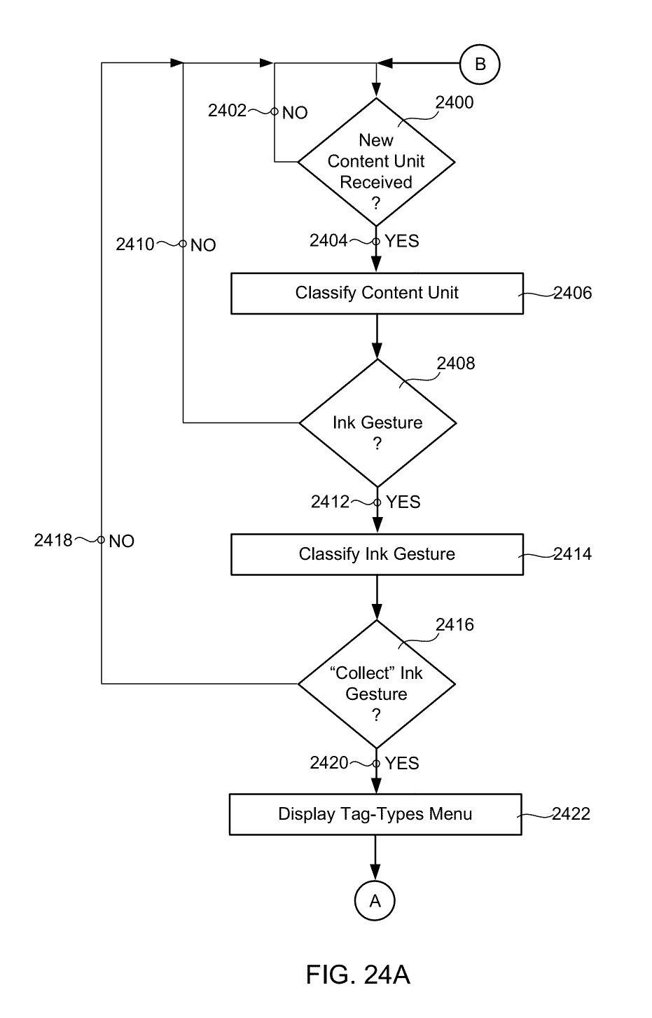

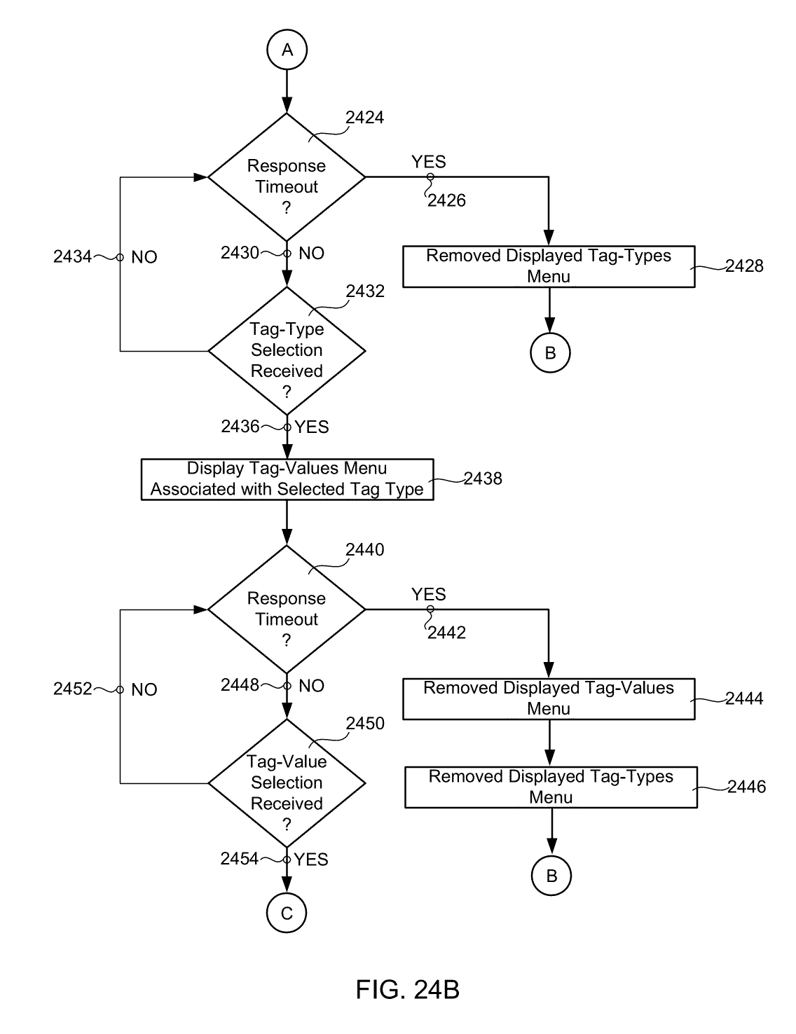

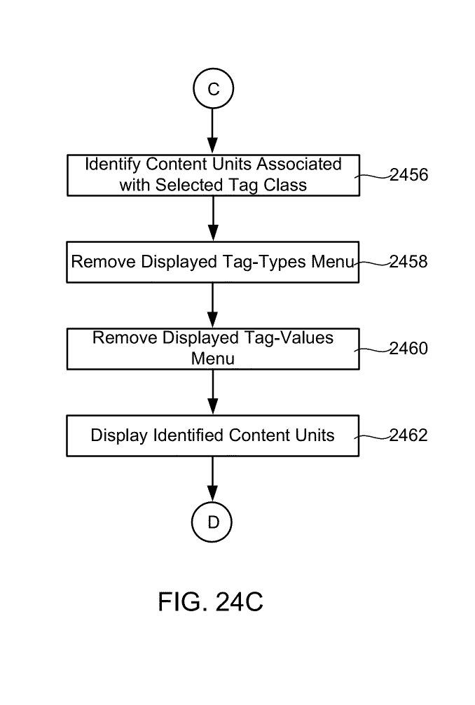

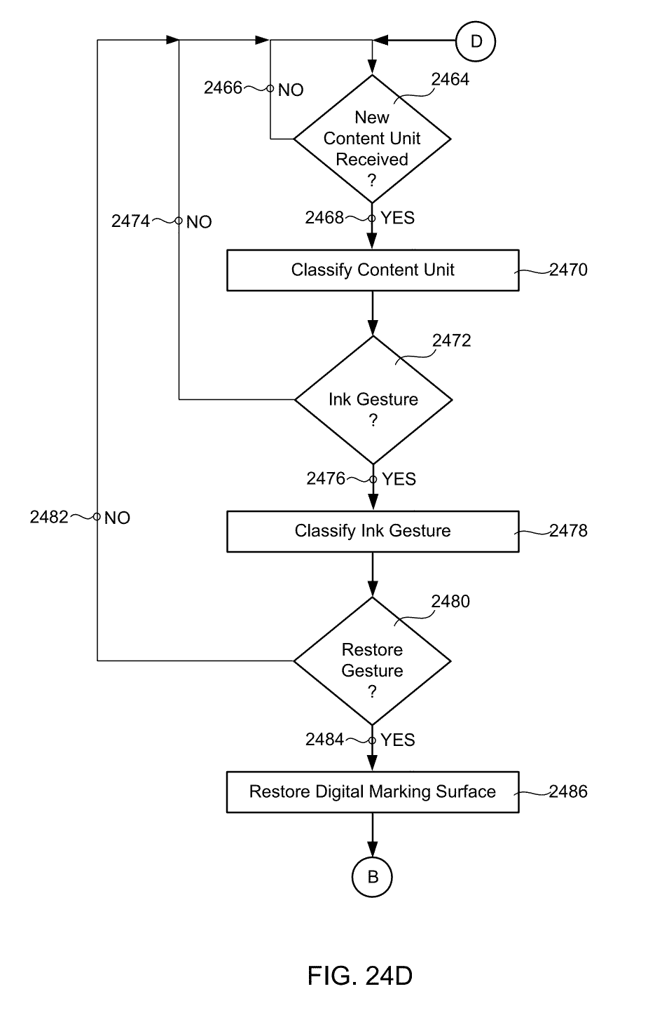

Some embodiments of the present invention may be described in relation to FIG. 24A, FIG. 24B, FIG. 24C and FIG. 24D. A determination may be made 2400 as to whether or not a new content unit has been received. If a new content unit has not been received 2402, then the content-unit monitoring 2400 may continue. If a new content unit has been received 2404, then the received content unit may be classified 2406. The content-unit classification results may be examined 2408 to determine if the received content unit may be classified as an ink gesture. If the received content unit may not be classified 2410 as an ink gesture, then the content-unit monitoring 2400 may continue. If the received content unit may be classified 2412 as an ink gesture, then the ink gesture may be classified 2414. The ink-gesture classification results may be examined 2416 to determine if the ink gesture may be classified as a “collect” ink gesture. If the ink gesture may not be classified 2418 as a “collect” ink gesture, then the content-unit monitoring 2400 may continue. If the ink gesture may be classified 2420 as a “collect” ink gesture, then a menu of tag types may be displayed 2422 in spatial proximity to the “collect” ink gesture. The time elapsed since the display of the tag-types menu may be examined 2424, and if the elapsed time is greater than a timeout value 2426, then the tag-types menu may be removed 2428 from the digital marking surface, and the content-unit monitoring 2400 may continue. If the elapsed time is not greater than the timeout value 2430, then a determination may be made 2432 as to whether or not a tag-type selection has been received. If a tag-type selection has not been received 2434, then the elapsed-time monitoring 2432 may continue. If a tag-type selection has been received 2436, then a menu of tag values associated with the selected tag type may be displayed 2438. The time elapsed since the display of the tag-values menu may be examined 2440, and if the elapsed time is greater than a timeout value 2442, then the tag-values menu may be removed 2444 from the digital marking surface, and the tag-types menu may be removed 2446 from the digital marking surface. The content-unit monitoring 2400 may continue. If the elapsed time is not greater than the timeout value 2448, then a determination may be made 2450 as to whether or not a tag-value selection has been received. If a tag-value selection has not been received 2452, then the elapsed-time monitoring 2440 may continue. If a tag-value selection has been received 2454, then any content units tagged with the selected tag type may identified 2456. The tag-types menu may be removed 2458 from the digital marking surface, the tag-values menu may be removed 2460 from the digital marking surface and the identified content units may be displayed 2462. In some embodiments of the present invention, displaying 2462 the identified content units may comprise clearing the viewport of previously displayed content units and displaying the identified content units.

A determination may be made 2464 as to whether or not a new content unit has been received. If a new content unit has not been received 2466, then the content-unit monitoring 2464 may continue. If a new content unit has been received 2468, then the received content unit may be classified 2470. The content-unit classification results may be examined 2472 to determine if the received content unit may be classified as an ink gesture. If the received content unit may not be classified 2474 as an ink gesture, then the content-unit monitoring 2464 may continue. If the received content unit may be classified 2476 as an ink gesture, then the ink gesture may be classified 2478. The ink-gesture classification results may be examined 2480 to determine if the ink gesture may be classified as a “restore” ink gesture. If the ink gesture may not be classified 2482 as a “restore” ink gesture, then the content-unit monitoring 2464 may continue. If the ink gesture may be classified 2484 as a “restore” ink gesture, then the digital marking surface may be restored 2486 to the pre-collect action display. The content-unit monitoring 2400 may continue.

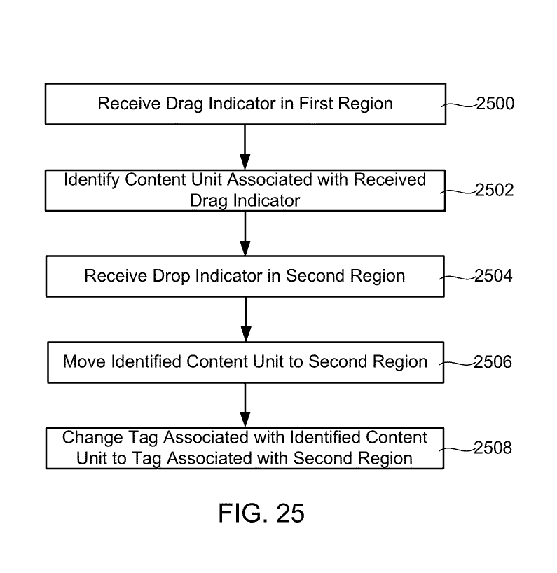

Some embodiments of the present invention may be described in relation to FIG. 25. In a collection view, a drag indicator may be received 2500 in a first region associated with a first collection of content units associated with a first tag value. A content unit associated with the received drag indicator may be identified 2502. A drop indicator may be received 2504 in a second region associated with a second collection of content units associated with a second tag value. The identified content unit associated with the received drag indicator may be moved 2506 from the first region to the second region, and the tag associated with the indentified content unit may be changed 2508 to the second tag value.

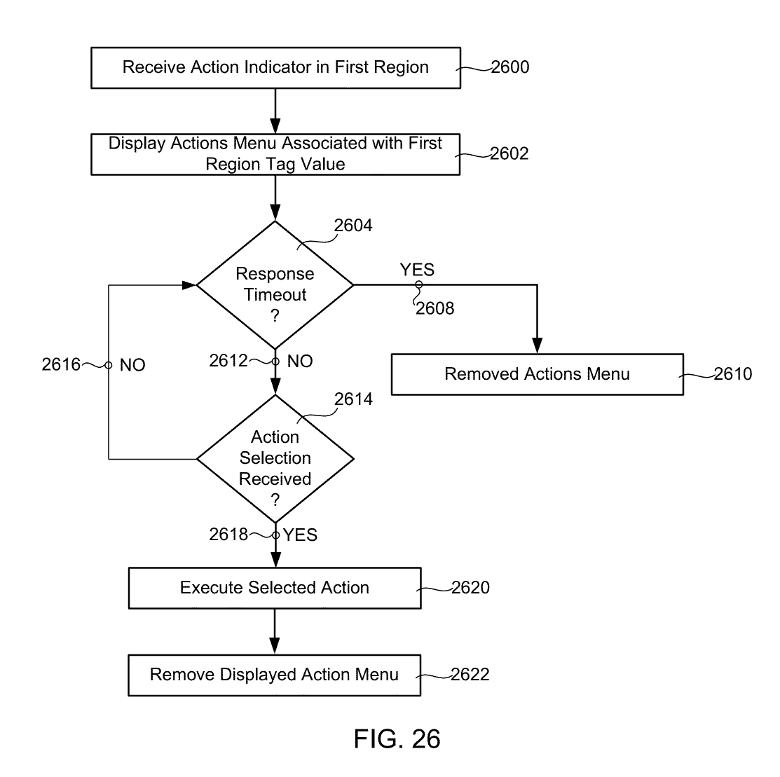

Some embodiments of the present invention may be described in relation to FIG. 26. An action indicator may be received 2600 in a first region associated with a first collection of content units associated with a first tag value. In some embodiments of the present invention an action indicator may be a touch gesture, an ink gesture or another indicator in a region spatially proximate to a tag label in a collection view. A menu of actions associated with the first tag value may be displayed 2602. The time elapsed since the display of the actions menu may be examined 2604, and if the elapsed time is greater than a timeout value 2608, then the actions menu may be removed 2610 from the digital marking surface. If the elapsed time is not greater than the timeout value 2612, then a determination may be made 2614 as to whether or not an action selection has been received. If an action selection has not been received 2616, then the elapsed-time monitoring 2604 may continue. If an action selection has been received 2618, then the selected action may be executed 2620. The actions menu may be removed 2622 from the digital marking surface.

In some embodiments of the present invention, a collect action may collect and display soft tagged content units and hard tagged content units. In some of these embodiments, a soft tagged content unit may be displayed with a first display feature, and a hard tagged content unit may be displayed with a second display feature. For example, a hard tagged content unit may be displayed as created, while a soft tagged content unit may be displayed with a highlight display feature. In some embodiments of the present invention, a user may perform a touch gesture in a spatially proximate region to a soft tagged content unit, thereby switching the tag association from soft to hard. In some embodiments of the present invention, when a soft tag association, for a content unit, is manually verified, a tagging pattern corresponding to the content unit and the tag value may be validated.

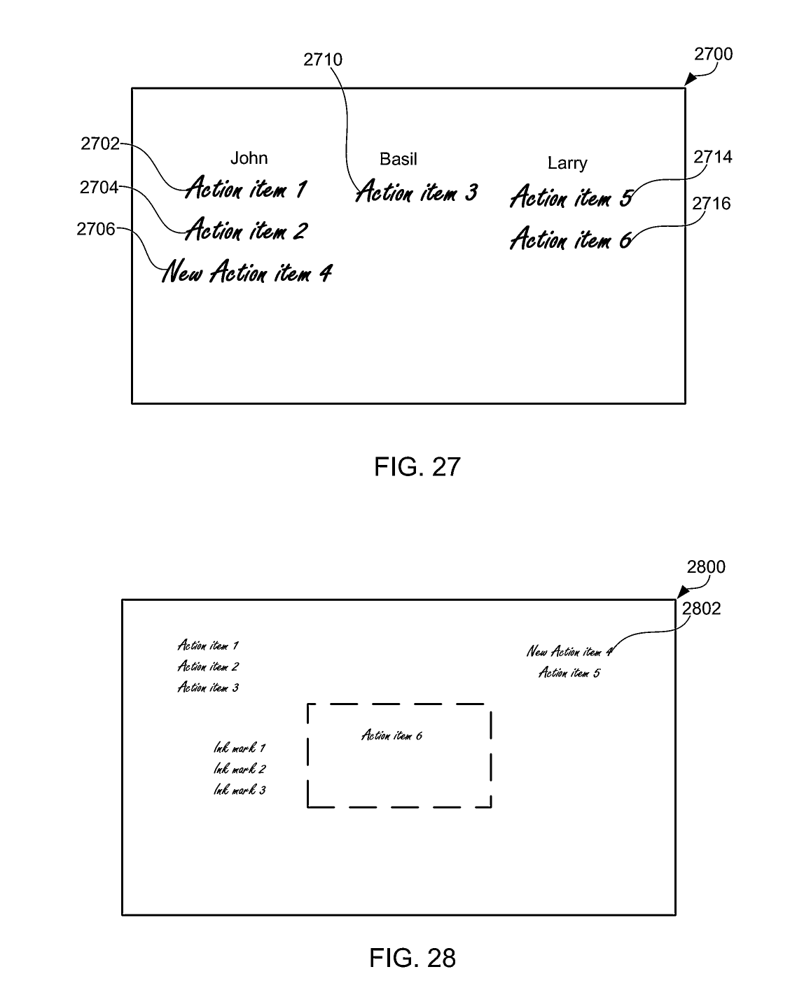

In some embodiments of the present invention, described in relation to FIG. 11, FIG. 27 and FIG. 28, a first content unit may be modified in a collection view. Upon receiving a “restore” ink gesture, the modified content unit may be restored to the location from which the first content unit was collected in the collect action. FIG. 27 depicts a viewport 2700, corresponding to the viewport 1100 in FIG. 11 after a content-unit modification to a first content unit 1106, in this example, an ink unit 1106. In FIG. 27, the two ink units tagged “John” 2702, 2704, the ink unit tagged “Basil” 2710 and the two ink units tagged “Larry” 2714, 2716 correspond directly to the two ink units tagged “John” 1102, 1104, the ink unit tagged “Basil” 1110 and the two ink units tagged “Larry” 1114, 1116 in FIG. 11. The ink unit “New Action item 4” 2706 in FIG. 27 is a modification of the ink unit “Action item 4” 1106 from FIG. 11. When a “restore” ink gesture is received, the modified ink unit 2706 may be restored to the location 2802 from which the corresponding original ink item was collected as illustrated in the exemplary digital sheet 2800 shown in FIG. 28.

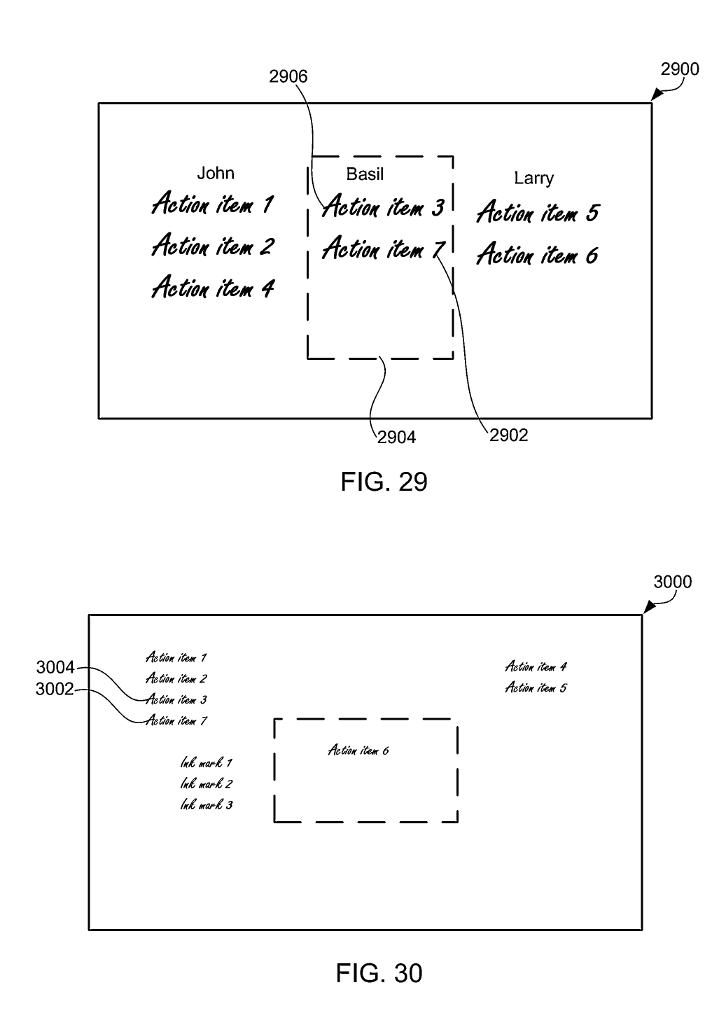

In some embodiments of the present invention, described in relation to FIG. 11, FIG. 29 and FIG. 30, a new content unit may be added in a collection view. The new content unit may be tagged with a tag value associated with the region in which the new content unit was placed in the collection view. Upon receiving a “restore” ink gesture, the new content unit may be restored to a location spatially proximate to one, or more, of the like-tagged content units. FIG. 29 depicts a viewport 2900, corresponding to the viewport 1100 in FIG. 11 after a content-unit addition in which ink unit “Action item 7” 2902 has been placed on the digital-marking-surface in a region 2904 associated with the “Basil” tag. When a “restore” ink gesture is received, the new ink unit “Action item 7” 2902 may be restored to a location 3002 spatially proximate to the location 3004 from which a like-tagged ink unit 2906 was collected as illustrated in the exemplary digital sheet 3000 shown in FIG. 30.

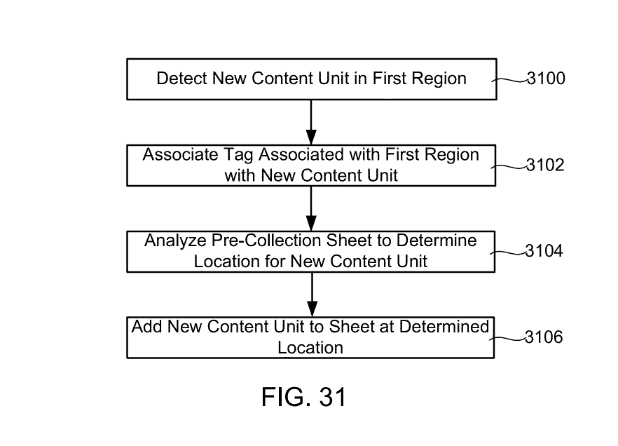

Some embodiments of the present invention may be understood in relation to FIG. 31. In a collection view, a new content unit may be detected 3100 in a first region associated with a first tag. The first tag may be associated 3102 with the new content unit. A pre-collection digital sheet corresponding to the digital sheet when the “collect” tag was received may be analyzed 3104 to determine a location for the new content unit. The analysis may comprise determining the locations of first-tag tagged content units on the pre-collection digital sheet and selecting a location spatially proximate to one, or more, of the first-tag tagged content units. In some embodiments of the present invention, locations associated with first-tag tagged content units that are spatially closer to the new content unit in the collection view may be given higher priority as candidate new-content-unit locations. In alternative embodiments of the present invention, regions with a higher density of first-tag tagged content units may be given higher priority than regions with a lower density of first-tag tagged content units. The new content unit may be added 3106 to the pre-collection digital sheet at the determined location. Upon receiving a “restore” ink gesture, the pre-collection digital sheet may be restored as the current digital sheet.

The use of ink units in illustrating embodiments of the present invention is by way of example, and not limitation. It is to be understood that embodiments of the present invention accord manipulation of, tagging and re-tagging of, collection of, modification of, restoration of, addition of new and operation of all functions claimed herein on all types of content units, not merely those content units used to illustrate embodiments of the present invention.

Some embodiments of the present invention may comprise a computer program product comprising a computer-readable storage medium having instructions stored thereon/in which may be used to program a computing system to perform any of the features and methods described herein. Exemplary computer-readable storage media may include, but are not limited to, flash memory devices, disk storage media, for example, floppy disks, optical disks, magneto-optical disks, Digital Versatile Discs (DVDs), Compact Discs (CDs), micro-drives and other disk storage media, Read-Only Memory (ROMs), Programmable Read-Only Memory (PROMs), Erasable Programmable Read-Only Memory (EPROMS), Electrically Erasable Programmable Read-Only Memory (EEPROMs), Random-Access Memory (RAMS), Video Random-Access Memory (VRAMs), Dynamic Random-Access Memory (DRAMs) and any type of media or device suitable for storing instructions and/or data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method, said method comprising:
in a digital-marking-surface system:
receiving a first content unit;
analyzing said first content unit to determine whether said first content unit conforms to a first ink gesture associated with a content-unit-collection action;
when said first content unit conforms to said first ink gesture:
determining a first tag value;
collecting a first plurality of content units associated with said first tag value; and
displaying said first plurality of content units in a viewport associated with said digital-marking-surface system.

2. A method as described in claim 1, wherein said determining a first tag value comprises:
displaying a tag-values menu in said viewport;
receiving a first tag-value selection, wherein said first tag-value selection is associated with a first tag-values menu item; and
setting said first tag value based on said first tag-value selection.

3. A method as described in claim 2 further comprising:
when said receiving a first tag-value selection does not occur within a first time interval relative to said displaying a tag-values menu:
removing said tag-values menu from said viewport; and
foregoing:
said setting said first tag value based on said first tag-value selection;
said collecting a first plurality of content units associated with said first tag value; and
said displaying said first plurality of content units in a viewport associated with said digital-marking-surface system.

4. A method as described in claim 1, wherein said determining a first tag value comprises:
displaying a tag-types menu in said viewport;
receiving a first tag-type selection, wherein said first tag-type selection is associated with a first tag-types menu item;
displaying a tag-values menu in said viewport, wherein a plurality of tag-values menu items are associated with said first tag-type selection;
receiving a first tag-value selection, wherein said first tag-value selection is associated with a first tag-values menu item; and
setting said first tag value based on said first tag-value selection.

5. A method as described in claim 4 further comprising:
when said receiving a first tag-value selection does not occur within a first time interval relative to said displaying a tag-values menu:
removing said tag-types menu from said viewport;
removing said tag-values menu from said viewport; and
foregoing:
said setting said first tag value based on said first tag-value selection;
said collecting a first plurality of content units associated with said first tag value; and
said displaying said first plurality of content units in a viewport associated with said digital-marking-surface system

6. A method as described in claim 4 further comprising:
when said receiving a first tag-type selection does not occur within a first time interval relative to said displaying a tag-types menu:
removing said tag-types menu from said viewport; and
foregoing:
said displaying a tag-values menu;
said receiving a first tag-value selection;
said setting said first tag value based on said first tag-value selection;
said collecting a first plurality of content units associated with said first tag value; and
said displaying said first plurality of content units in a viewport associated with said digital-marking-surface system.

7. A method as described in claim 1, method as described in claim 1, wherein said determining a first tag value comprises:
displaying a tag-types menu;
receiving a first tag-type selection, wherein said first tag-type selection is associated with a first tag-types menu item; and
setting said first tag value based on said first tag-type selection.

8. A method as described in claim 7 further comprising:
when said receiving a first tag-type selection does not occur within a first time interval relative to said displaying a tag-types menu:
removing said tag-types menu from said viewport; and
foregoing:
said setting said first tag value based on said first tag-type selection;
said collecting a first plurality of content units associated with said first tag value; and
said displaying said first plurality of content units in a viewport associated with said digital-marking-surface system.

9. A method as described in claim 1, wherein said determining a first tag value comprises:
identifying a second content unit, wherein said second content unit is located spatially proximate to said first content unit;
identifying a second-content-unit tag value associated with said second content unit; and
setting said first tag value to said second-content-unit tag value.

10. A method as described in claim 1, wherein each content unit in said first plurality of content units is displayed, in said viewport, in spatial proximity to a label identifying said first tag value.

11. A method as described in claim 1 further comprising clearing said viewport prior to said displaying.

12. A method as described in claim 1 further comprising:
receiving a second content unit;
analyzing said second content unit to determine whether said second content unit conforms to a second ink gesture associated with a restore action; and
when said second content unit conforms to said second ink gesture, restoring said viewport to a condition immediately prior to receiving said first content unit.

13. A method as described in claim 12, wherein said second ink gesture is a spiral shape with a pen-down point at the innermost point of said spiral shape and a pen-up point at the outermost point of said spiral shape.

14. A method as described in claim 12, wherein said first ink gesture is a spiral shape with a pen-down point at the outermost point of said spiral shape and a pen-up point at the innermost point of said spiral shape.

15. A method as described in claim 12, wherein:
said first ink gesture and said second ink gesture are the same shape;
a pen-up point in said first ink gesture corresponds to a pen-down point in said second ink gesture; and
a pen-down point in said first ink gesture corresponds to a pen-up point in said second ink gesture.

16. A method as described in claim 1 further comprising:
receiving a second content unit;
analyzing said second content unit to determine whether said second content unit conforms to a second ink gesture associated with a restore action; and
when said second content unit conforms to said second ink gesture, restoring a digital sheet associated with said digital-mark-surface system to a pre-collection digital sheet.

17. A method as described in claim 16 further comprising:
receiving a modification to a third content unit; and
replacing said third content unit in said pre-collection digital sheet with said modified third content unit.

18. A method as described in claim 16 further comprising:
receiving a new content unit in a region associated with said first tag;
associating said first tag with said new content unit;
analyzing said pre-collection digital sheet to select a location to place said new content unit; and
writing said new content unit to said selected location on said pre-collection digital sheet.

19. A method as described in claim 16, wherein said second ink gesture is a spiral shape with a pen-down point at the innermost point of said spiral shape and a pen-up point at the outermost point of said spiral shape.

20. A method as described in claim 16, wherein said first ink gesture is a spiral shape with a pen-down point at the outermost point of said spiral shape and a pen-up point at the innermost point of said spiral shape.

21. A method as described in claim 16, wherein:
said first ink gesture and said second ink gesture are the same shape;
a pen-up point in said first ink gesture corresponds to a pen-down point in said second ink gesture; and
a pen-down point in said first ink gesture corresponds to a pen-up point in said second ink gesture.

22. A method as described in claim 1 further comprising:
determining a second tag value;
collecting a second plurality of content units associated with said second tag value;
displaying said second plurality of content units in said viewport;
receiving a drag indicator in a first region of said viewport, wherein said first region is associated with said first plurality of content units;
identifying a drag-and-drop content unit, from said first plurality of content units, associated with said drag indictor;
receiving a drop indicator in a second region of said view port, wherein said second region is associated with said second plurality of content units;
removing said drag-and-drop content unit from a current display location;
displaying said drag-and-drop content unit at a new display location associated with said second plurality of content units; and
associating said second tag value with said drag-and-drop content unit.

23. A method as described in claim 1 further comprising:
receiving an action indicator in a first region of said viewport, wherein said first region is associated with said first plurality of content units;
displaying an actions menu associated with said first tag value;
receiving a first action selection, wherein said first action selection is associated with a first actions menu item;
executing said first action; and
removing said action-menu from said viewport.

24. A method as described in claim 23 further comprising:
when said receiving a first action selection does not occur within a first time interval relative to said displaying an actions menu:
removing said actions menu from said viewport; and
foregoing said executing said first action.

25. A method as described in claim 1, wherein said first ink gesture is a spiral shape with a pen-down point at the outermost point of said spiral shape and a pen-up point at the innermost point of said spiral shape.

26. A method as described in claim 1, wherein:
said first ink gesture and a second ink gesture associated with a viewport-restore action are the same shape;
a pen-up point in said first ink gesture corresponds to a pen-down point in said second ink gesture; and
a pen-down point in said first ink gesture corresponds to a pen-up point in said second ink gesture.

27. A method, said method comprising:
in a digital-marking-surface system:
receiving a first content unit;
analyzing said first content unit to determine whether said first content unit conforms to a first ink gesture associated with a content-unit-tagging action; and
when said first content unit conforms to said first ink gesture:
determining a first tag value;
determining a second ink unit located spatially proximate to said first content unit;
associating said first tag value with said second content unit; and
removing said first content unit from said viewport.

28. A method as described in claim 27, wherein said determining a first tag value comprises:
displaying a tag-values menu, in a viewport associated with said digital-marking-surface system, in spatial proximity to said first content unit;
receiving a first tag-value selection, wherein said first tag-value selection is associated with a first tag-values menu item; and
setting said first tag value based on said first tag-value selection.

29. A method as described in claim 28 further comprising:
when said receiving a first tag-value selection does not occur within a first time interval relative to said displaying a tag-values menu:
removing said tag-values menu from said viewport; and
foregoing:
said setting said first tag value based on said first tag-value selection;
said determining a second content unit located spatially proximate to said first ink unit;
said associating said first tag value with said second content unit; and
said removing said first content unit from said viewport.

30. A method as described in claim method as described in claim 27, wherein said determining a first tag value comprises:
displaying a tag-types menu, in a viewport associated with said digital-marking-surface system, in spatial proximity to said first content unit;
receiving a first tag-type selection, wherein said first tag-type selection is associated with a first tag-types menu item;
displaying a tag-values menu in said viewport, wherein a plurality of tag-values menu items are associated with said first tag-type selection;
receiving a first tag-value selection, wherein said first tag-value selection is associated with a first tag-values menu item; and
setting said first tag value based on said first tag-value selection.

31. A method as described in claim 30 further comprising:
when said receiving a first tag-value selection does not occur within a first time interval relative to said displaying a tag-values menu:
removing said tag-types menu from said viewport;
removing said tag-values menu from said viewport; and
foregoing:
said setting said first tag value based on said first tag-value selection;
said determining a second content unit located spatially proximate to said first ink unit;
said associating said first tag value with said second content unit; and
said removing said first content unit from said viewport.

32. A method as described in claim 30 further comprising:
when said receiving a first tag-type selection does not occur within a first time interval relative to said displaying a tag-types menu:
removing said tag-types menu from said viewport; and
foregoing:
said displaying a tag-values menu;
said receiving a first tag-value selection;
said setting said first tag value based on said first tag-value selection;
said determining a second content unit located spatially proximate to said first ink unit;
said associating said first tag value with said second content unit; and
said removing said first content unit from said viewport.

33. A method as described in claim method as described in claim 27, wherein said determining a first tag value comprises determining a tag value associated with said first content unit.

34. A non-transitory, computer-readable medium comprising instructions that when executed instruct a processor in a digital-marking-surface system to:
analyze a first content unit to determine whether said first content unit conforms to a first ink gesture associated with a content-unit-collection action; and
when said first content unit conforms to said first ink gesture:
determine a first tag value;
collect a first plurality of content units associated with said first tag value; and
display said first plurality of content units in a viewport associated with said digital-marking-surface system.

35. A non-transitory, computer-readable medium as described in claim 34 further comprising instructions to:
analyze a second content unit to determine whether said second content unit conforms to a second ink gesture associated with an viewport-restore action; and
when said second content unit conforms to said second ink gesture, restore said viewport to a condition immediately prior to receiving said first content unit.

36. A non-transitory, computer-readable medium as described in claim 35 further comprising instructions to restore a digital sheet associated with said digital-mark-surface system to a pre-collection digital sheet.

37. A non-transitory, computer-readable medium as described in claim 36 further comprising instructions to:
receive a modification to a third content unit; and
replace said third content unit in said pre-collection digital sheet with said modified third content unit.

38. A non-transitory, computer-readable medium as described in claim 36 further comprising instructions to:
receive a new content unit in a region associated with said first tag;
associate said first tag with said new content unit;
analyze said pre-collection digital sheet to select a location to place said new content unit; and
write said new content unit to said selected location on said pre-collection digital sheet.

39. A non-transitory, computer-readable medium as described in claim 34 further comprising instructions to:
determine a second tag value;
collect a second plurality of content units associated with said second tag value;
display said second plurality of content units in said viewport;
receive a drag indicator in a first region of said viewport, wherein said first region is associated with said first plurality of content units;
identify a drag-and-drop content unit, from said first plurality of content units, associated with said drag indictor;
receive a drop indicator in a second region of said view port, wherein said second region is associated with said second plurality of content units;
remove said drag-and-drop content unit from a current display location;
display said drag-and-drop content unit at a new display location associated with said second plurality of content units; and
associate said second tag value with said drag-and-drop content unit.

40. A non-transitory, computer-readable medium as described in claim 34 further comprising instructions to:
receive an action indicator associated with a first region of said viewport, wherein said first region is associated with said first plurality of content units;
display an actions menu associated with said first tag value;
receive a first action selection, wherein said first action selection is associated with a first actions menu item;
execute said first action; and
remove said action-menu from said viewport.

41. A non-transitory, computer-readable medium comprising instructions that when executed instruct a process in a digital-marking-surface system to:
analyze a first content unit to determine whether said first content unit conforms to a first ink gesture associated with a content-unit-tagging action; and
when said first ink unit conforms to said first ink gesture:
determine a first tag value;
determine a second content unit located spatially proximate to said first content unit;
associate said first tag value with said second content unit; and
remove said first content unit from a viewport associated with said digital-marking-surface system.
